(19) United States
(12) Patent Application Publication
(10) Pub. No.: US 2010/0252187 A1
(43) Pub. Date: Oct. 7, 2010

(54) Methods of Making Customized Articles for Applying Color on Surfaces

(76) Inventors: Jonathan Javier Calderas, Cincinnati, OH (US); Jeremy Peter Carrle, Blue Ash, OH (US); Richard Martin Ward, Mason, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/417,291

(22) Filed: Apr. 2, 2009

(51) Int. Cl. B32B 38/14; B41J 2/00

(52) U.S. Cl. 156/277; 347/110

(57) ABSTRACT

A decorative dry color laminate includes a dry color layer, a pressure-sensitive adhesive layer on one side of the dry color layer, and a carrier in releasable contact with the dry color layer on a side opposite from the pressure-sensitive adhesive (PSA). In use, the adhesive layer adheres the dry color laminate to the surface under application of pressure, and the carrier is peeled away to expose the dry color layer. Methods for providing a substantially permanent color effect on an architectural surface comprise delivering such an article to the architectural surface.

### FIELD OF THE INVENTION

The present invention is directed to articles for applying color on a surface, for example an architectural surface. Methods of making such articles, and methods of applying color on a surface are also described.

### BACKGROUND OF THE INVENTION

It is often desirable to apply one or more colors to a surface, for example an architectural surface such as an interior or exterior wall or the like, for aesthetic benefits or other purposes. Color is typically provided by conventional painting with water-based or oil-based wet paints, application of wallpaper or the like. In spite of the benefits provided by applying color on a surface by wet painting or wall papering, the efforts required in connection with such procedures are inconvenient and time consuming.

Numerous attempts have been made to decorate surfaces in alternative manners. Such attempts include those described in the following patent publications: U.S. Pat. No. 4,054,697, Reed; U.S. Pat. No. 5,322,708, Eissele; U.S. Pat. No. 5,413,829, Brown, et al.; U.S. Pat. No. 6,703,089, DeProspero, et al.; U.S. Pat. No. 6,916,532 B2, Yanagiuchi; U.S. patent application Ser. Nos. 11/904,941 and 11/904,774, both filed on Sep. 28, 2007, which published on Apr. 3, 2008 as U.S. Patent Application Publication Nos. 2008/0081142 A1 and 2008/0078498 A1, respectively; EP Patent 0 569 921, Smith; and, PCT Publication WO 94/03337.

The search for improved articles for applying color on a surface, methods of making such articles, and methods of applying color on a surface has, however, continued. In particular, it may be desirable for such articles to have a virtually seamless and paint-like appearance. It is also desirable to improve the quality and efficiency of printing such articles. It also is desirable for the method of making such articles to allow a sufficient variety of designs to be produced while minimizing inventory and manufacturing complexity.

### SUMMARY OF THE INVENTION

The present invention is directed to articles for applying color on a surface, for example an architectural surface. Methods of making such articles, and methods of applying color on a surface are also described. There are numerous non-limiting embodiments of the present invention.

In one aspect, the invention is directed to articles for applying color on a surface. In one non-limiting embodiment, the invention is directed to a multi-layer laminate for providing a layer of color to a substrate surface. The laminate includes a dry color layer and a pressure-sensitive adhesive layer for adhering the laminate to the substrate surface. In one version, the color layer is a decorative dry paint layer. In this version, the laminate includes a flexible structural layer between the dry color layer and the adhesive layer. The structural layer provides structural support for the dry color layer. The structural layer may optionally also serve other purposes, for example, the structural layer may also serve to provide additional opacity for the dry color layer. The structural layer may optionally also serve as a discoloration prevention barrier layer to reduce or eliminate migration of pigments or dyes (particularly azo-type pigments or dyes) in a painted substrate into the color layers of the laminate, which would cause discoloration of the color layers. The structural layer may also optionally serve as a formation web upon which the other layers of the laminate may be formed during the process of making the laminate. The laminate further optionally includes a carrier in releasable contact with the dry color layer on a side opposite from the pressure-sensitive adhesive (PSA). In use, the adhesive layer adheres the laminate to the substrate surface under application of pressure, and the carrier is peeled away to expose the dry color layer.

The multi-layer laminate can be made in a number of different manners. In one non-limiting embodiment, the laminate is made by initially using the structural layer as a formation web upon which the other layers of the laminate may be formed. The structural layer can, for instance, have layers formed thereon in the following order: one or more optional opacifying layers, one or more optional priming layers, one or more color layers, one or more optional patterns or print coats, and one or more topcoats. The carrier can be formed separately with an adhesive release coat on one side (for engaging the pressure sensitive adhesive layer when the laminate is in roll form) and a release surface on the surface that will face the topcoat. The carrier can then be releasably joined to the topcoat. The pressure sensitive adhesive layer can also be formed separately and then joined to the structural layer.

In another aspect, the invention is directed to methods for providing a substantially permanent color effect on an architectural surface. In one embodiment, the methods comprise delivering an article according to one of the embodiments described above to the architectural surface.

### BRIEF DESCRIPTION OF THE DRAWINGS

The following detailed description will be more fully understood in view of the drawings in which:

FIG. 1 is a schematic diagram showing the layers of one embodiment of an article for applying color on a surface according to the present invention;

FIG. 1A is a schematic diagram of an alternative embodiment of an article for applying color to a surface, which article comprises a dual layer adhesive;

FIG. 1B is a schematic diagram of another alternative embodiment of an article for applying color to a surface, which article comprises an opacifying layer on each side of the structural layer;

FIG. 2 is a schematic diagram of one process for producing a dry color component for use in the article;

FIG. 3 is a schematic diagram of one embodiment of the manner in which the components of the article shown in FIG. 1 are assembled;

FIG. 3A is a plan view showing a portion of a method of creating a random pattern for an article for applying color on a surface.

FIG. 3B is a schematic diagram of one process for an inline system for producing an article;

FIG. 4 is a perspective view of the device used in the “Bubble Test”.

FIG. 5 is an enlarged perspective view showing one example of the surface texture of a section of primed U.S. drywall material.

FIG. 6 is a further enlarged schematic cross-sectional view showing one example of an article for applying color to a surface which achieves a degree of conformability with the surface of the underlying drywall material.

FIG. 7 is an enlarged schematic cross-sectional view showing one example of an article for applying color to a surface which achieves relatively poor conformability with the surface of the underlying drywall material.

The embodiments shown in the drawings are illustrative in nature and are not intended to be limiting of the invention defined by the claims. Moreover, individual features of the drawings and the invention will be more fully apparent and understood in view of the detailed description.

### DETAILED DESCRIPTION

The present invention is directed to articles for applying color on a surface, for example an architectural surface. Methods of making such articles, and methods of applying color on a surface are also described.

### Dry Color Laminate

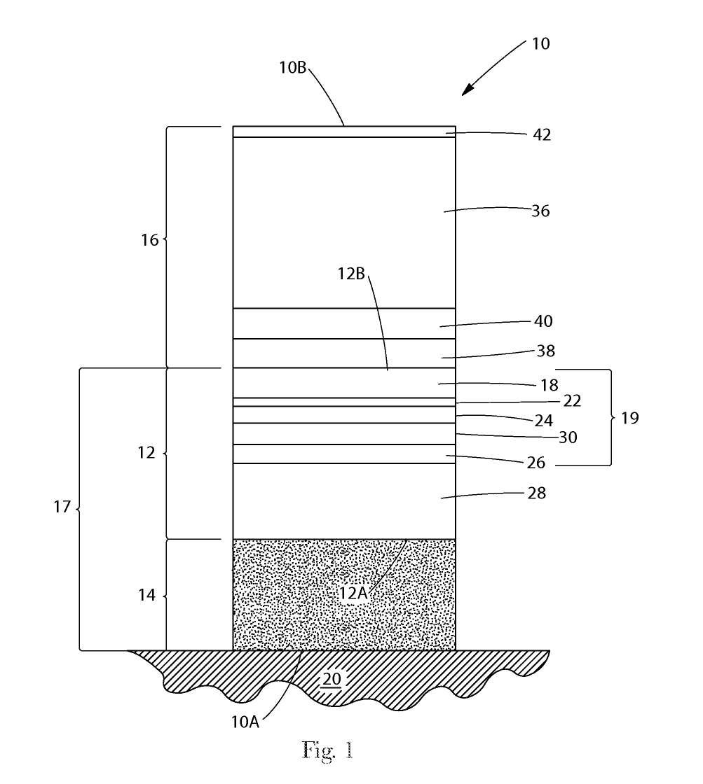

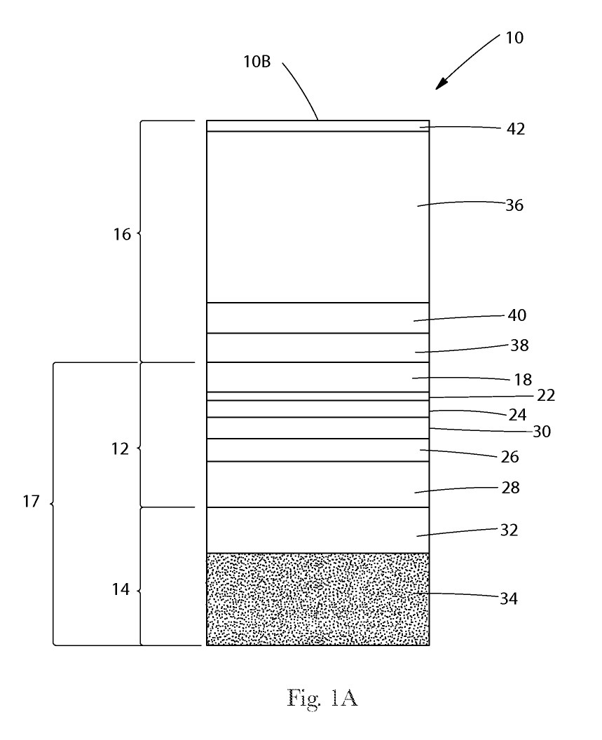

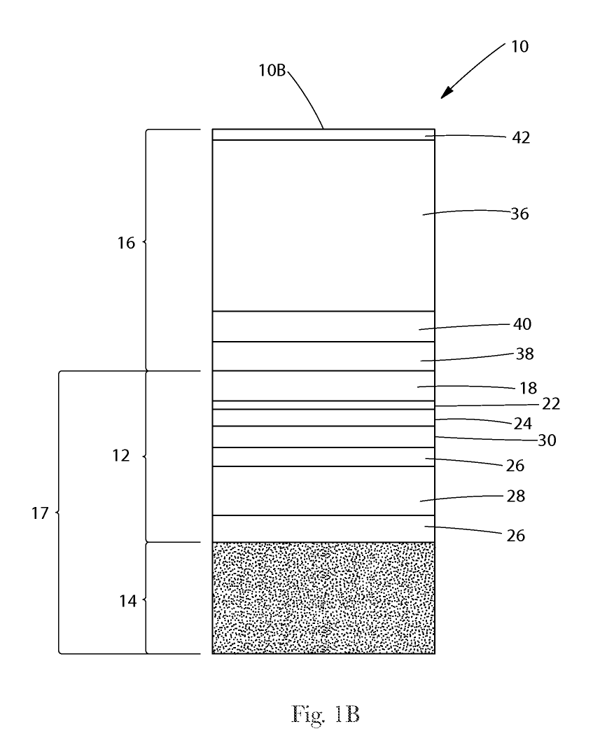

FIG. 1 shows one non-limiting embodiment of an article according to the present invention applied to a substrate surface 20. The article comprises a multi-layer dry color laminate 10, which may be in the form of a multi-layer sheet or film. It should be understood that only one layer of the laminate needs to be colored. It is not necessary that all of the layers of the laminate be colored. The dry color laminate may provide attributes of abrasion resistance, solvent resistance and opacity similar to conventional wall paints. The dry color laminate is adapted to be applied to architectural surfaces such as interior and exterior walls of buildings, building fixtures or appliances, furniture, and the like. In cases in which the dry color laminate is applied to walls, it may be referred to herein as a “wall film”. The dry color laminate may be repositionable during application, and substantially permanently adherable to the surface thereafter.

As shown in FIG. 1, the multi-layer dry color laminate 10 comprises a dry color component 12. The dry color component 12 has a first surface (or “inner surface”) 12A facing toward the surface 20 to which the dry color laminate 10 is applied, and a second surface (or “outer surface”) 12B facing away from the surface 20 to which the dry color laminate is applied. There is an adhesive 14 on, or joined to, the first surface 12A of the dry color component, and a carrier structure 16 on, or joined to, the second surface 12B of the dry color component 12. In this embodiment, the carrier structure 16 will be removed once the dry color laminate is applied to the surface 20. In other embodiments, the carrier structure 16 may be optional and omitted. The portion of the dry color laminate 10 that remains on the substrate surface 20 after removal of the carrier structure 16 will comprise the dry color/adhesive component (which may be referred to herein as the “surface covering component”), and designated by reference numeral 17.

The term “joined to”, as used in this specification, encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The term “joined to” encompasses configurations in which an element is secured to another element at selected locations, as well as configurations in which an element is completely secured to another element across the entire surface of one of the elements.

In the embodiment shown, the dry color component 12 comprises several sub-components. These comprise, from the outer surface 12B to the inner surface 12A: one or more topcoats 18; one or more patterns or print coats 22; a color coat 24 in the form of one or more layers; one or more opacifying coats or layers 26, an optional priming layer 30, and, a structural layer 28. Each of these has a first surface (or “outer surface”) facing away from the surface 20 to which the dry color laminate is applied, and a second surface (or “inner surface”) facing toward the surface 20 to which the dry color laminate is applied. The topcoat 18, patterns or print coats 22, color coat 24, and opacifying coats or layers 26 may be referred to herein together as the “dry color element” (or the “dry color layers” or “decorative component”) 19, although the topcoat need not be colored. The carrier structure 16 may also comprise several sub-components or elements. These may include one or more of the following: a carrier sheet 36; a first release surface, release surface or release layer 38; an adhesive layer 40; and, a second release surface, adhesive release coat layer 42.

It should be understood that while the schematic diagram of FIG. 1 shows relative thicknesses of the components of the decorative dry color laminate, the illustrated thicknesses provide no limitation on actual thicknesses of the respective components in the embodiment of FIG. 1 or in any of the embodiments of the remaining figures. Additionally, while the interface between the components is shown as a clearly defined line, the actual interface between components may comprise other, different or less defined configurations.

Topcoat

The topcoat 18 may provide the dry color component 12 with one or more protective qualities of abrasion resistance, water or solvent resistance, UV protection, and toughness of conventional paint, and/or may provide recoatability over the pigmented dry color layer or layers underlying it. In one embodiment, the topcoat is a transparent or substantially transparent clear coat layer. The topcoat can also provide the dry color component with the desired level of surface gloss, or visual effects such as pearlescence, fluorescence, or the like. The topcoat adheres to the carrier structure 16, which is adapted to release from the topcoat during or after application to the substrate surface 20.

The topcoat 18 may be in any suitable form, including in the form of a layer or coating. The topcoat may comprise a single layer or coat, or multiple layers or coats. If the topcoat comprises more than one layer or coat, the different layers can be comprised of the same material, or different materials. (The same is true of the other layers of the multi-layer laminate.) The topcoat may be printed, extruded, or it may be formulated from the various solvents described herein and applied by casting or coating techniques. In one non-limiting embodiment, the topcoat is gravure printed. The thickness of the topcoat may range generally from about 0.01 to about 0.4 mil (about 0.25-10 microns (μm)), from about 0.01 to about 0.3 mil (about 0.25-8 μm), or from about 0.02-0.12 mils (0.5-3 μm). These thicknesses and all of the other thicknesses specified herein refer to dry film thicknesses.

The topcoat 18 may comprise any of the polymeric binder or resin materials described herein for use in the color layer. In one embodiment, the topcoat comprises an acrylic resinous material, such as poly (ethyl methacrylate). One suitable resin is ELVACITE® 2042 resin from the Lucite International Company. The dry color laminate 10 may be provided with desired gloss characteristics through the use of particles (for example, protruding particles) included in the topcoat 18 (that is, a “filled” topcoat), post-treatment, or texturization (embossing). In one embodiment, the dry color laminate may have a matte finish, and the topcoat can contain a dispersed filler or flattening agent such as silica to lower the gloss of the matte finish of the dry color laminate. The characteristics of the topcoat may also be altered through printing, post-treatment or texturization (embossing) specific regions of the overall surface to create differing gloss, texture, or color. These regions may further comprise a defined pattern for aesthetic purposes and/or functional purposes. The patterns may, for example, be used to hide seams when sheets of the laminate are placed on a substrate next to one another, and preferably overlapped. Patterns suitable for this purpose are described in U.S. Patent Application Publication No. US 2004/0076788 A1.

Providing the dry color laminate 10 with the desired gloss characteristics through the use of texturization (embossing) can provide the advantages of allowing greater control over the gloss characteristics. For example, the gloss may be changed by altering the pattern of an embossing cylinder instead of either reformulating the topcoat, or providing additives into the topcoat. This allows the composition of the topcoat to remain the same. Manufacturing efficiency can be improved since gloss changes can easily be achieved by changing the embossing pattern and avoiding the cleaning and changeover required for changing between different filled topcoats. The dry color laminate may also be provided with two or more regions with different glosses using techniques such as texturization.

Providing the dry color laminate 10 with the desired gloss characteristics through the use of texturization (embossing) can result in a surface topology with a dimpled/cratered surface (negative skew) rather than the protruding surface features (positive skew) as is the case for a printed flattening agent described above. Incident light is scattered from the fine surface features formed into the topcoat rather than from the features obtained from the added flattening agent. The embossed pattern can be transferred to topcoat surfaces comprised of thermoplastic materials with a combination of time, pressure, and temperature causing the surface to conform to a patterned master surface such as an embossing cylinder or belt. For topcoats produced by cured polymer systems such as UV or electron beam receptive topcoats, the embossing operation can be done by contacting the uncured topcoat surface with the desired embossing surface during the curing operation. In one such embodiment, the topcoat is comprised of a UV resin that is substantially free of flattening agent, and a textured film is used to modify the surface of the topcoat. The UV resin is first applied to the printed surface, and then the textured film is brought into contact with the resin layer. The resin is then cured using UV energy while the textured film is still in contact with the resin. The textured film is then removed, leaving a modified textured topcoat surface. The texture may be micro roughened, or have more pronounced texture as desired.

In alternate embodiments, the topcoat or texturization can be provided by digital printing on an in-line process. For example, the Kodak Nexpress from Kodak, Rochester, N.Y., U.S.A, uses an imaging station with Dimensional Clear Dry ink to provide texturization to printed materials. In this method, the substrate is printed with the color and pattern, and then printed with the texturized topcoat.

The gloss can alternatively be changed by texturization (embossing) of the entire dry color laminate by yielding the overall structure with sufficient time, temperature and pressure (embossing conditions) to cause permanent deformation of the laminate.

A patterned topcoat surface may be designed such that the negative impression provides the desired surface on the finished product. In one embodiment, simple patterns from blast media on metal plates can form surfaces in the embossed product with varying degrees of gloss. The degree of surface feature transfer from the embossing plate is controlled by the embossing conditions. In one embodiment, gloss levels of finished product measured by the specular reflectance of a beam of light at 85° could be manipulated from a value of 13 gloss units (matte) to a value of 30 gloss units (sheen) again by varying the size of the surface features on the embossing plates and the conditions of the embossing process.

Surface features can be embossed into the product to provide optical effects and change the tactile nature of the resulting surface. Holographic or prismatic effects are produced when a fine pattern in the surface acts to diffract the incoming light. These effects may also be combined with macroscopic patterns for aesthetic purposes and/or functional purposes such as seam hiding as described above. The surface roughness along with the coefficient of friction of the material can be varied to change the tactile feel of the product surface.

Print Coats

The one or more patterns or print coats (or “grains”) 22 comprise decorative components that may be used to provide the dry color component 12 with a design that is visible through the topcoat. The patterns 22 can be used for aesthetic purposes and/or functional purposes. The patterns may, for example, be used to hide seams when sheets of the laminate are placed on a substrate next to one another, and preferably overlapped. Patterns suitable for this purpose are described in U.S. Patent Application Publication No. US 2004/0076788 A1. Additionally, the print coat patterns may be used to build opacity of the overall dry color laminate.

The patterns or print coats 22 may comprise one or more polymeric binders or resins and one or more pigments dispersed in the binder or resin. The inks or dyes used to form the patterns 22 can be opaque, or translucent. The patterns 22 can be provided in any suitable structure, including, but not limited to layers, or in the form of printed arrays or elements. The patterns 22 can comprise areas where there is color, and areas which are devoid of color. The areas that are devoid of color will appear to be transparent, clear, or free of the pattern so that portions of the color coat 24 can be seen through the patterns 22. The areas that are devoid of color may be larger in total than the areas where there is color. In other embodiments, the opposite relationship may be present.

There can be any suitable number of patterns or print coats 22, including 1, 2, 3, 4, 5, etc. In one non-limiting embodiment, the patterns 22 comprise two or more printed arrays, one of which is printed on top of the other. In one version of such a dry color component, the two patterns are each in the form of a printed array, one printed array is printed with blue or gray ink, and the other is printed with brown or tan ink. In one embodiment, the patterns 22 may be very thin, such as less than or equal to about 1 μm in thickness, and in some cases, less than or equal to about 0.5 μm.

In other embodiments, digital printing may be used to apply inks or dyes to provide a color layer or to provide both the pattern and color layer. In such cases, the print coat and color layer may be delivered in the same layer. Typical suitable technologies for digital printing include but are not limited to aqueous inkjet, UV inkjet, solvent inkjet, electrophotography, and may use liquid toner, powder toner, and dye sublimation. Digital printing typically uses separate inks such as cyan, magenta, yellow and black (known as “CMYK”) to achieve a wide gamut of colors. Additional inks may be added to expand the color gamut. Alternatively, inks may be removed for cost reasons or to reduce manufacturing complexity. Digital printing typically involves a process of applying a plurality of deposits of color marking material, such as ink or toner, on the article to be printed. The color marking material may comprise deposits that are transparent, translucent, opaque, or combinations thereof.

Color Layer

The color layer 24 can comprise any suitable element or structure that provides the dry color laminate with color. The color layer may, for example, comprise inks, paints, colored films, metalized films, opacified films, pigmented adhesives, lacquers, solid pigments, planchettes (suspended textile or cellulose fibers), or any other structure or element that provides the dry color laminate with color. In other embodiments, however, the color layer and/or the dry color laminate may be substantially free of textile or cellulose.

In one non-limiting embodiment, the color layer comprises a paint, and more specifically one or more layers of dry paint. In such an embodiment, the color layer may, therefore, also be referred to herein as a “dry paint layer”. The dry color layer may also provide at least portions of the dry color laminate with at least a degree of opacity. The dry color layer 24 should be substantially free of any liquid carriers after the formation of the dry color layer is completed. The dry color layer may be in any suitable form, including in the form of a layer or coating. The dry color layer may comprise a single layer or coating, or multiple layers or coats. As in the case of the print coats 22, the color layer 24 can be provided in any suitable structure, including, but not limited to layers, or in the form of printed arrays or elements.

In one non-limiting embodiment, the dry color layer 24 comprises a paint composition comprising a solid coloring material, i.e., one or more pigments, suspended in a liquid medium and applied directly or indirectly to a carrier such as the structural layer 28, followed by drying to form a flexible opaque dry color film.

The dry color layer or layers 24 may comprise one or more polymeric binders or resins and one or more pigments dispersed in the binder or resin. These layers may be made from solvent cast liquid paint compositions. These compositions may be dispersed in water, or in one or more organic solvents, and optionally may contain one or more additional additives for controlling processing properties. In some embodiments, the dry color layer is essentially non-fibrous. The color layer may be formed by coating techniques such as roll coating including reverse roll coating, gravure printing including reverse gravure, flexographic, offset lithography, letterpress, silk screen, or in combinations such as flexographic/screen, letterpress/offset lithography, etc., slot die, and curtain coating. In other embodiments, the dry color layers, and/or the topcoat layer may each comprise independently one or more extruded layers, including those formed by co-extrusion and extrusion coating. In other embodiments, digital printing may be used to apply inks, toner, or dyes to provide a color layer, to provide both the pattern and color layers, or to provide combined pattern and color layers as described above. In the latter case, layers 22 and 24 may be combined into a single layer.

The combination of the pattern and color layers, along with any underlying tinted and/or opacity layers (including any opacifying properties of the adhesive) form an image on the surface of the articles described herein. The term “image” refers to the combination of any design or pattern and any background color for the design or pattern. The image may, but need not be that of an object. More typically, the image will be more in the nature of a random design or faux finish design. The image described herein is durable in that it is not designed to be removed in whole or in part from the remainder of the article. When the articles are applied to an architectural surface, the image will be oriented in the typical normal viewing orientation for a human whose eye line is generally parallel to the floor or ground.

Any suitable binder or resin may be used in the dry color layer(s). The binder may, for example, comprise a thermoplastic or thermosetting resin. Examples of useful binders or resins generally include synthetic latex resins, acrylic, vinyl, polyester, alkyd, butadiene, styrene, urethane, cellulosic, and epoxy resins and mixtures thereof. For example, the binder or resin may include one or more polystyrenes; polyolefins, including polyethylenes and polypropylenes; polyamides; polyesters; polycarbonates; polyvinylidene fluoride; polyvinyl chloride (PVC); polyvinyl alcohol; polyethylene vinyl alcohol; polyurethanes, including aliphatic and aromatic polyurethanes; polyacrylates; polyvinyl acetates; ionomer resins, cellulosic polymers, and mixtures thereof. In certain embodiments, however, it may be desirable for the dry color layers, or even the entire multi-layer laminate 10 to be substantially free of polyvinyl chloride.

The pigment may be any pigment used in making decorative coatings. These include opacifying pigments, such as titanium dioxide and zinc oxide, as well as tinting pigments known in the art. Filler pigments, such as clay, silica, talc, calcium carbonate, kaolin clay and mica, can be added as well in conventional amounts traditionally used in coating and paint formulations. Digital inks or toners which are typically designed for applications such as printing documents, signage, photos, labels, or other such usages may also be used.

The solvent may be one or more organic-based solvents or water, or a water-based solution may be used to form an aqueous emulsion with the binder or resin. Water-based solutions include water-alcohol mixtures. In other embodiments, the dry color layer(s) can be made from solvent-free coatings (e.g., UV curable coatings) for ease of processing. UV inks typically comprise a resin, a pigment or other colorant, and an initiator. UV inks typically are solvent-free and are printed or coated as a liquid resin. The resin is then exposed to UV light which solidifies the liquid resin.

Additional ingredients that may be used include wetting agents; plasticizers; suspension aids; coalescing agents, surfactants, thickeners, thixotropic agents such as silica; water repellant additives such as polysiloxane compounds; fire retardant additives; biocides; bactericides; defoamers; and flow agents. In certain embodiments, however, it may be desirable for the dry color layers, or even the entire multi-layer laminate to be substantially free of plasticizers.

By way of example, the pigment concentration for certain embodiments of the liquid paint or coating composition used to form the dry color layers may range from about 0.4% to about 38% by weight, or alternatively from about 13% to about 27% by weight when applied by gravure printing. The binder or resin concentration may range from about 12% to about 40% by weight, or from about 22% to about 37% by weight. The water or organic solvent concentration may range from about 30% to about 85% by weight for gravure, or from about 40% to about 60% by weight. Additional ingredients such as wetting agents, suspension agents, etc., may have concentrations up to about 5% by weight. The coating or paint compositions used in making the dry color layers may have a pigment volume concentration (pigment volume divided by total volume of non volatile components) from about 9% to about 16%.

The color layer(s) may have a combined thickness in any suitable range, including but not limited to the following ranges: from about 0.05 to about 0.5 mils (about 1.2-13 μm); from about 0.05 to about 0.3 mils (or less than about 0.3 mils) (about 1.2-8 μm), from about 0.06 to about 0.2 mil (about 1.5-5 μm), and from about 0.08 mil to about 0.16 mil (about 2-4 μm).

Priming Layer

In certain embodiments, a priming layer or layers may be used to enhance print adhesion, improve color vibrancy, or to control dot gain (or ink bleeding). Herein, “dot gain” refers to the increase in dot size when inks are applied to the substrate as well as the bleeding or feathering of the dot as it spreads on the substrate. The term “dot gain” is further described in U.S. Pat. No. 6,803,933 B1, Staelin, et al. The primer may be transparent, translucent, or colored. A commercial example of a transparent primer is IJ-1007 NS available from Cork Industries, Inc., Folcroft, Pa. U.S.A. One example of a commercially available translucent primer suitable for use with aqueous inks is IJ-1014 also available from Cork Industries, Inc. In one embodiment, the primer is applied using rod coating to deliver 5 to 10 gsm dry basis. Alternately, gravure, microgravure or other coating methods known in the art may be used to apply the primer layer or layers.

The IJ-1007NS coating comprises hydrophilic polymers. The IJ-1014 coating comprises hydrophilic polymers, particles such as alumina and silica, and crosslinking acrylic polymer to bind the solid particles. In its dried state, the IJ-1014 primer has a porous structure capable of absorbing aqueous solvents. This structure, along with the hydrophilic polymers, allows the aqueous based inks to fix on the surface of the coated layer. The water absorption capacity and absorption rate of the priming layer or layers can be adjusted so that aqueous inks do not bleed or mix together with other inks before the ink pigments are fixed on the surface during printing. In addition, the surface energy of the ink or substrate may be modified to adjust the absorption rate and adhesion of ink to the substrate.

In typical digital graphic print applications such as photographs or labels, minimal ink bleed or dot gain is desired to maintain sharp edges or fine features in photographs or text. In contrast, for the articles described herein, it may be desirable to modify the surface to intentionally allow a degree of dot gain, bleed or feathering. This increased spreading of the inks may be useful for masking printing color defects by allowing ink boundaries between print heads to blur slightly while maintaining vibrant color.

As used herein, dot gain is calculated as follows:

% dot gain=(printed dot diameter)/(theoretical ink droplet diameter)

Where:
printed dot diameter=Maximum Feret diameter (defined below) of physical dot after ink is transferred and dried on substrate
theoretical ink droplet diameter=theoretical diameter of ink droplet assuming a sphere-shaped droplet.

In one embodiment, the article is printed using aqueous inkjet inks with an estimated volume of 4 Pico liters per individual drop. Assuming perfect spherical droplets, the theoretical diameter of a 4 Pico liter dot (4000 cubic microns) is 20 microns.

In one embodiment, the Cork IJ-1014 primer is modified by adding additional hydrophobic polymers to increase the ratio of hydrophobic to hydrophilic polymers and to decrease the surface energy and porosity of the primer layer. The addition of hydrophobic polymers produces dots that are larger and are more irregular than the unmodified primer. Samples printed on substrates with a dried coat weight of approximately 10 gsm and comprising 10% to 20% additional hydrophilic polymers versus the starting formulations (also coated at approximately 10 gsm dry weight basis) provided improvement in both color vibrancy and reduction of print defects.

The aforementioned primed substrate samples are printed with an Epson C88 aqueous inkjet printer available from Seiko Epson Corporation, Nagano, Japan with individual cyan, magenta, yellow and black inks to determine the percent increase in dot size relative to both the unmodified primer (control) and to the theoretical dot diameter. Pictures of samples are taken with a ProScope USB microscope available from Bodelin Technologies, Lake Oswego, Oreg. U.S.A. The digital files are then analyzed using Image J 1.421 software by U.S. National Institutes of Health, Bethesda, Md., U.S.A. to determine the maximum Feret diameter for multiple drops and the average of the maximum Feret diameter for all the drops. The Feret diameter, F, is defined as the perpendicular distance between parallel lines, tangent to the perimeter at opposite sides of a 2D object in a certain direction.

Dot Gain Examples

| | | (Printed Dot | Dot Gain |
|---|---|---|---|
| | | Diameter)/ | (Printed Dot |
| | | (Printed Dot | Diameter)/ |
| | Printed | Diameter on | (Theoretical |
| | Dot | Cork IJ-1014 | Ink Droplet |
| | Diameter | Primer) | Diameter) |
| Sample | (microns) | (%) | (%) |
| Cyan on Cork IJ-1014 | 49 | — | 245 |
| primer (control) | | | |
| Cyan on Cork IJ-1014 | 53 | 108 | 265 |
| primer with 10% | | | |
| hydrophilic polymers | | | |
| added | | | |
| Cyan on Cork IJ-1014 | 61 | 124 | 305 |
| primer with 20% | | | |
| hydrophilic polymers | | | |
| added | | | |
| Magenta on Cork IJ- | 44 | — | 220 |
| 1014 primer | | | |
| Magenta on Cork IJ- | 48 | 109 | 240 |
| 1014 primer with 10% | | | |
| hydrophilic polymers | | | |
| added | | | |
| Magenta on Cork IJ- | 67 | 152 | 335 |
| 1014 primer with 20% | | | |
| hydrophilic polymers | | | |
| added | | | |
| Yellow on Cork IJ- | 54 | — | 270 |
| 1014 primer | | | |
| Yellow on Cork IJ- | 64 | 119 | 320 |
| 1014 primer with 10% | | | |
| hydrophilic polymers | | | |
| added | | | |
| Yellow on Cork IJ- | 75 | 139 | 375 |
| 1014 primer with 20% | | | |
| hydrophilic polymers | | | |
| added | | | |
| Black on Cork IJ-1014 | 69 | — | 345 |
| primer | | | |
| Black on Cork IJ-1014 | 85 | 123 | 425 |
| primer with 10% | | | |
| hydrophilic polymers | | | |
| added | | | |
| Black on Cork IJ-1014 | 88 | 128 | 440 |
| primer with 20% | | | |
| hydrophilic polymers | | | |
| added | | | |

In some embodiments, it is desirable for the primer to be selected so that the dot gain of at least one dot (or any number of dots greater than one) of printed ink is greater than or equal to any of the following amounts: 125%, 130%, 135%, 140%, 145%, 150%, and any 5% increment above 150%. In other embodiments, it may be desirable for the average dot gain for all of the drops in a particular printed article, or a portion thereof, to be greater than or equal to the above amounts.

If multiple priming layers are used, the absorption, surface properties, clarity or color of each layer may be configured to achieve desired quality.

In alternate embodiments, it may be beneficial to use surface treatments such as corona treatment or plasma treatment to modify the surface to accept the digital inks. Such treatments may be used in conjunction with or in place of a primer.

Opacity Layers

The dry color laminate may have one or more opacifying or opacity layers 26 underlying the dry color layer(s). The opacity layers may be in any suitable form including in the form or layers or coatings. The opacity layers may comprise one or more polymeric binders or resins and one or more pigments dispersed in the binder or resin. The opacity layers may, for example, comprise white ink layers containing TiO₂, metalized films, filled films, or other structures that provide the dry color laminate with additional opacity. Metalized film opacity layers may, for example, be formed by depositing an evaporative metal on the structural layer.

The opacity layers may be in any suitable location, including on either or both sides of the structural layer 28. In one non-limiting embodiment, the opacity layers comprise one or more white ink layers on the side of the structural layer closest to the topcoat. In another embodiment, the opacity layers comprise one or more white ink layers on each side of the structural layer. FIG. 1B shows an example of a dry color laminate having a structural layer with opacity layers printed on both surfaces of the structural layer.

The opacity layers may be tinted or colored similarly to the value or hue of the color layers to minimize the color difference between the overlying color layers to minimize seam appearance. This will minimize the visibility of the edges on the multi-layer laminate. The opacity layers may be tinted in any suitable manner, such as by using color ink to print the opacity layers, or if the opacity layers comprise a separate web (such as the structural layer) by adding colored pigment during the manufacture of the opacity layers. Tinting of opacity layers may be beneficial when used in conjunction with inkjet digital printing since it may reduce print defects from misaligned print heads, blocked print head nozzles or non-uniform print heads. In addition, tinted opacity layers can be used to reduce digital ink usage since a portion of the color may provided by traditional gravure or flexographic inks which are typically substantially less expensive than digital inks. Finally, the tinted opacity may be used to expand the digital printing color gamut by providing custom colors or metallic effects that may not achievable with a combination of typical digital inks.

It may be desirable for the tinted layer to be at least partially visible through the print and color layers (and any color marking material comprising the same). If the deposits of color making material are translucent, the tinted layer may be at least partially visible through at least some of the deposits of the color marking material. In addition, even if some of the deposits of the color marking material are opaque, the tinted layer may be at least partially visible between at least some of the deposits of the color marking material.

The image formed by the print and/or color coats and the opacity layer typically has light reflective properties, and has a most reflective portion, as well as an average color. The most reflective portion and average color are determined by measuring the image with a spectrophotometer, such as an X-Rite hand held spectrophotometer available from X-Rite America, Grand Rapids, Mich., U.S.A. The average color is defined as the mean reflectance from all areas, at each wavelength. The maximum reflectance from all areas, at each wavelength, defines the lightest color within the design and is presented as (% reflectance from 400-710 nm). The measurement area diameter or port used for measuring and determining the reflectance of the image must be small enough to measure within individual design elements, shapes, lines, etc. while being at least five times as large in diameter as the printed dots comprising the image. In practice, the image can be printed at larger scale for measurement with a larger port instrument.

The properties of the tinted layer and the image are expressed herein in terms of the CIE 1976 (L*, a*, b*) color space specified by the International Commission on Illumination (Commission Internationale d'Eclairage). It may be desirable for the tinted layer to have a color that is at least as reflective at wavelengths of between 400-710 nm (visible wavelengths) as the most reflective portion within the image. In addition, it may be desirable for the tinted layer to have an L* value of less than or equal to about 92, alternatively less than or equal to about 84, alternatively, less than or equal to about 75. It also may be desirable for the tinted layer to have a difference in color of less than or equal to about 60, alternatively, less than or equal to about 45, alternatively less than or equal to about 35 dE*_{ab} than the average color of the image.

The opacity layer(s) may have a combined thickness in any suitable range, including but not limited to the following ranges: from about 0.05 to about 0.5 mils (about 1.2-13 μm); from about 0.05 to about 0.3 mils (or less than about 0.3 mils) (about 1.2-8 μm), and from about 0.06 to about 0.3 mil (about 1.5-8 μm). In the case of metalized film opacifying layers, the opacifying layer may be thinner, for example, as low as 100-300 Angstroms (10-30 nanometers or 0.01-0.03 microns).

Structural Layer

The structural layer (or “support layer” or “reinforcing layer”) 28 provides structural support for the dry color layer(s). The structural layer can optionally also serve other purposes, such as to provide additional opacity for the dry color layer and/or serve as a discoloration prevention barrier layer. In the latter case, the structural layer may serve as a barrier to reduce or eliminate migration of pigments or dyes (particularly azo-type pigments or dyes) in a painted substrate into the color layers of the laminate, which would cause discoloration of the color layers. The structural layer may also serve as a formation web upon which the other layers of the laminate may be formed during the process of making the laminate. The structural layer may have a tensile strength which exceeds that of the dry color layer or layers.

The structural layer can comprise any suitable material that is capable of permitting the structural layer to serve one or more of the functions specified above for the structural layer. Suitable materials for the structural layer include, but are not limited to films made of polypropylene, polyethylene (including LDPE and HDPE), polyester, polyethylene terephthalate (PET), polyamides (e.g., nylon), polystyrene, polyurethane, and ethylene vinyl alcohol (EVOH), as well as metalized films. In certain embodiments, the structural layer may comprise a pre-formed self-supporting polymeric film (that is, a film which is not formed in situ, for example, as a coating, during the process of making the laminate). More particularly, the structural layer may be a pre-formed axially-oriented, semi-crystalline polymeric film. In certain embodiments in which it is desirable for the structural layer to provide discoloration barrier benefits, the structural layer may comprise a film selected from the group consisting of polyester, polyethylene terephthalate (PET), and polyamides. A non-limiting example of a commercially available film is Toray LuMirror F53 14G 3.5 μm biaxially oriented PET film from Toray Industries, Inc. of Tokyo, Japan. In some cases, the structural layer may contain one or more of the above-described pigments to enhance opacity of the finished laminate. The concentration of pigment in the structural layer, when used, may be in any suitable range, including up to about 40% by weight, and from about 6 to about 10% by weight. The structural layer may alternatively, or additionally have one or more opacity layers printed on either, or both of its surfaces as described above. In addition, if the structural layer is also used to provide the laminate with opacity, this can allow the amount of pigment in the dry color layer(s) to be reduced.

The dry color layers, outer topcoat layer or structural layer independently may contain inorganic fillers or other organic or inorganic additives to provide desired properties such as appearance properties (transparent, opaque, or colored films), durability and processing characteristics. Examples of useful materials include calcium carbonate, titanium dioxide, metal particles, fibers, flame retardants, antioxidant compounds, heat stabilizers, light stabilizers, ultraviolet light stabilizers, antiblocking agents, processing aids, and acid acceptors.

One or more of the dry color layers, opacity layers, outer topcoat layer or structural layer may contain a minor amount of an adhesive resin to enhance the adhesion thereof to adjacent layers. Also, or alternatively, tie coat layers of an adhesive resin can be used between any of the layers described herein. The adhesive resin for the tie coat can be an acrylic resin adhesive, or it can be an ethylene/vinyl acetate copolymer adhesive such as those available from DuPont under the tradename ELVAX™. The adhesive resins available from DuPont under the tradename BYNEL™ also may be used.

In certain embodiments, it may be desirable for the structural layer 28 to be flexible, and to exhibit at least a minimal level of extensibility, but to be substantially non-elastic (substantially non-elastomeric) at room temperature under those forces acting on it during application of the laminate to the substrate surface. In other embodiments, the structural layer 28 may be substantially inextensible or non-stretchable. The decorative dry color laminate may be provided with other properties so that it is capable of conforming closely to very small textures of substrate surfaces, even when the structural layer is substantially inextensible. In some embodiments, at least some of the other components of the multi-layer laminate (the dry color layers, the opacity layer(s), and the outer topcoat layer, may also be flexible, but substantially inextensible and non-elastic at room temperature. In other embodiments, one or more of these components may be extensible, at least when such components are not joined directly or indirectly to an inextensible structural layer.

The structural layer 28 may be thicker than the print coats, the dry color layer(s) and/or the opacity layer(s). This may allow the structural layer to be the component of the laminate that is primarily responsible for providing the laminate with structural integrity. The structural layer may have a thickness in any suitable range. The thickness of the structural layer may fall within a range that includes but is not limited to the following ranges: from about 0.1 to 1 mil (2.5 to 25 microns); from about 0.1 to 0.5 mil (2.5 to 13 microns) or up to about 15 microns.

When the structural layer is used, the thicknesses of the dry color component 12 (that is, the combined thickness of the topcoat, the optional print coats, the color layer(s), opacity layer(s), and the structural layer) may be in any suitable range, including but not limited to the following ranges: from about 0.25 to about 1.5 mils (about 5-38 μm); from about 0.25 to about 1 mils (about 5-25 μm); or, from about 0.5-1 mils (about 13-25 μm).

Adhesive

The adhesive bonds the decorative laminate to a substrate surface under applied pressure, at room temperature. As used herein, the term “room temperature” refers to temperatures of from about 40° F. (4° C.) to less than 104° F. (40° C.), and includes any narrower range within that range. The adhesive may be in any suitable form, including but not limited to layers, coatings, and regular or irregular patterns of adhesive.

The adhesive may comprise any suitable adhesive including, but not limited to: pressure sensitive; water-based; water-borne; solvent based; ultraviolet and e-beam cured adhesives; hot melt pressure sensitive adhesives; water-based pressure sensitive adhesives; water-borne pressure sensitive adhesives; static adhesives; electrostatic adhesives; and combinations thereof. It is desirable for the adhesive to be substantially non-flowable so that the adhesive has little to no edge ooze when applied to the substrate surface.

In one embodiment, the adhesive comprises a dry adhesive layer comprising a pressure-sensitive adhesive (PSA). In one variation of such an embodiment, the adhesive layer is a repositionable adhesive, having a low initial tack that allows slight movement of the laminate to allow positioning adjustments prior to forming a more permanent bond. The adhesive may have a suppressed initial level of tack at room temperature that allows the laminate to adhere to a substrate surface and be repositioned thereon. The laminate is then typically smoothed or burnished, and this is followed by removal of the carrier structure from the dry color component. The adhesive may increase in its adhesion to the substrate surface as a result of application pressure and/or undergo a subsequent buildup of adhesion due to the passage of time sufficient to permanently bond the dry color component to the substrate surface.

In some embodiments, the pressure-sensitive adhesive comprises a cross-linked acrylic resinous material, and more particularly, a cross-linked acrylic emulsion. A particularly useful adhesive material comprises an internally cross-linked acrylic emulsion. High molecular weight acrylic adhesives and externally cross-linked acrylic adhesives also may be used to produce the desired combination of functional properties. Examples of useful PSAs in which the level of crosslinking can be appropriately adjusted include acrylic emulsion PSAs such as pure polymer (butyl acrylate or 2-ethyl hexyl acrylate or 2-ethyl hexyl acrylate/butyl acrylate) PSAs or similar pigmented polymer and copolymer materials. A particularly useful PSA is an internally cross-linked acrylic emulsion PSA such as a non-tackified cross-linked copolymer emulsion of butyl acrylate and 2-ethyl hexyl acrylate. This adhesive is available from Avery Dennison Corporation as product no. S-3506.

The adhesive layer also may contain one or more pigments to enhance the opacity of the color layers overlying it and permit use of thinner color layers to achieve desired levels of opacity. Any of the pigments identified above may be used. Examples include titanium dioxide and carbon black. The pigment volume concentration may be in any suitable range, including but not limited to the following ranges: up to about 10%; from about 5% to about 10%; or, from about 2% to about 8%. A pigmented form of product no. S-3506 PSA comprises 96.8% S-3506 adhesive resin, 2.87% Rohm and Haas UCD 1106E™ titanium dioxide pigment concentrate dispersion, and 0.33% UCD 1507E™ carbon black pigment concentrate dispersion, and is gray in color.

In the embodiment shown in FIG. 1A, the adhesive comprises a two layer (or two portion) structure comprising a first layer or portion of white adhesive 32 joined to an underlying second layer or portion of adhesive 34. The second layer of adhesive can be an unpigmented adhesive, or a layer of pigmented adhesive, such as the gray colored adhesive described above. The white adhesive layer is positioned between the structural layer and the second layer of adhesive. The layer of white adhesive may be used to increase the brightness of lighter colors when lighter colors are used in the overlying patterns and dry color layer by providing a white background beneath the color layers. The layer of gray adhesive provides the two layer adhesive structure with the desired repositionability and better adherence to the surface of the substrate than the white layer could alone (that is, it has a higher adhesion to the substrate surface than the white layer). A two layer adhesive structure is used because the levels of TiO₂ required to provide the layer of white adhesive with the opacity needed to avoid the underlying adhesive or surface showing through will not have sufficient adhesion to the substrate surface. In one non-limiting embodiment, the gray adhesive layer is a form of product no. S-3506 PSA described above which is compounded with 4% by dry weight of 92%/8% TiO₂/carbon black dispersions, and the white adhesive layer comprises a form of product no. S-3506 PSA described above which is compounded with 35%, by dry weight, of a TiO₂ dispersion.

The white adhesive layer 32, which may also be referred to as an opacifying adhesive layer, together with the gray colored adhesive layer 34, which may also be referred to as a substrate adhesive layer, may provide in excess of 50% of the opacity index of the total surface covering component 17. In one embodiment, the opacifying adhesive layer 32 alone can provide greater than 50% of the opacity index of the surface covering component.

In certain embodiments, it may be desirable to produce a substantial amount of the surface covering component's opacity in the relatively higher pigment content of the opacifying adhesive layer 32, so as to reduce the amount of light colored coatings needed in the color coat layers and still achieve complete opacity (an opacity index of greater than 99%) in the surface covering component. In one embodiment, the opacifying adhesive layer 32 produces from about 70% to about 90% of the total surface covering component opacity when containing from about 10% to about 40% solids by weight of the total resin/filler solids contained in the opacifying adhesive layer.

In one embodiment comprising the layer of gray colored adhesive 34 (used for surface covering components containing dark colored dry color layers), the gray colored pressure-sensitive adhesive layer provides greater than about 50% total opacity index for the surface covering component.

In certain embodiments, the adhesive may be such that the laminate may be repositioned by sliding the laminate relative to the surface of the substrate as opposed to peeling, removing, and replacing the laminate on the substrate.

The thickness of the adhesive layer, or the combined thickness of the adhesive layers if there is more than one layer, may be in any suitable range, including but not limited to the following ranges: from about 0.4 to about 1 mil (about 10-25 μm); or, from about 0.4 to about 0.8 mil (about 10-20 μm).

Carrier Structure

The carrier structure 16 provides structural integrity to the dry color laminate until the temporary carrier is removed upon application of the dry color laminate 10 to a substrate surface 20. The carrier structure 16 may comprise a single component or element. In certain embodiments, however, the carrier structure 16 can comprise several sub-components or elements. These may include one or more of the following: a carrier sheet or “carrier” 36; a first release surface, release surface or layer 38; an optional adhesion layer such as an adhesive layer (e.g., “carrier adhesive layer”) or a tie (or primer) layer 40; and, a second release surface, adhesive release coat layer 42.

The carrier sheet 36 may comprise any material suitable for this purpose including, but not limited to paper, and polymeric films such as films made of polypropylene, polyethylene (including LDPE and HDPE), polyethylene terephthalate (PET), polystyrene, polyurethane, and ethylene vinyl alcohol (EVOH), and combinations thereof. The carrier sheet may be formed from a thin, flexible, foldable, heat-resistant, substantially inelastic, self-supporting temporary carrier film or casting sheet. In certain embodiments, for example, the carrier sheet is an oriented polyester film such as polyethylene terephthalate (PET) available as MYLAR®, a trademark of DuPont, or Mitsubishi HOSTAPHAN 2000™ polyester film.

The thickness of the carrier sheet 36 may be in any suitable range, including but not limited to the following ranges: from about 0.5 to about 2 mils (about 13-50 μm); from about 0.5 to about 1.5 mils (about 13-38 μm); or, from about 0.6 to about 1.2 mils (about 15-30 μm). In certain embodiments, the thickness of the overall carrier structure 16 may also fall within the above ranges. Providing a thin carrier sheet 36 (less than 1 mil (about 25 μm)) allows the dry color laminate to be more easily be burnished, or smoothed during application, and to achieve the desired microconformability with the surface of the substrate.

The carrier sheet 36 has a release surface or layer (or “releasable coating”) 38 on the surface facing the topcoat 18. The release surface 38 may comprise any structure which releasably adheres to the topcoat, but does not dissolve the topcoat. The level of adhesion should be sufficient to prevent separation of the release surface 38 from the topcoat 18 during the process of forming the multi-layer laminate and during normal handling, including forming the multi-layer laminate in its self-wound orientation, unwinding it, and applying it to the substrate surface. The release surface 38, however, should have sufficient release properties to facilitate separation from the topcoat after applying the surface covering component to the substrate. In addition, it is desirable that the peel force between the release surface and topcoat does not increase or decrease substantially during storage as this can adversely impact the application experience by either delamination or excessive force needed to remove the carrier film. The release surface 38 should also preferably leave a minimum amount of residue, and more preferably, no residue on the topcoat surface. Several non-limiting examples of release surface systems are described herein.

In one embodiment, a multiple layer (e.g., a dual layer) release system is used for laminating the releasable carrier structure 16 to the topcoat surface and for controlling separation of the releasable carrier structure from the topcoat during use. The dual layer release system comprises a release layer 38 that produces a controlled release from the topcoat 18 when the releasable carrier structure 16 is removed from the topcoat during use. The dual layer release system also includes an adhesion layer such as a permanent adhesive layer or “carrier adhesive” 40. The adhesion layer may comprise a permanent pressure sensitive adhesive bonded to the carrier sheet 36. The permanent adhesive 40 may be initially laminated to the release layer 38 which has been coated on the dry color component 12. The release layer 38 may comprise a material that initially adheres to the topcoat 18 during drying, but by its tack-free condition will separate cleanly without affecting gloss and release from the topcoat when the releasable carrier structure 16 is peeled away from the topcoat 18 since it is bonded to the permanent adhesive layer 40 on the releasable carrier sheet 36. This release system allows the desired peel force to be selected, and the force will preferably be stable throughout storage and application.

It should be understood that the general references herein to the releasable carrier structure separating from the topcoat are for simplicity of discussion only. This description is intended to cover multi-layer laminate structures in which the releasable carrier structure 16 is releasably joined to not only the topcoat, but also structures in which there is no topcoat and the releasable carrier structure 16 is releasably joined to either the outermost pattern layer, or to the dry color layer.

In this embodiment, the release layer 38 comprises a coating of a polar, preferably a highly polar release material which in dry film form is tack-free at room temperature. This coating may be coated or printed on the topcoat, and dried. The release layer material 38 has a difference in polarity, preferably a substantial difference in polarity from that of the outer surface of the topcoat or dry color component 12. In one embodiment, the release layer material comprises a polar (hydrophilic) material, or a highly polar material, and the topcoat material is non-polar, or has a lower polarity. The topcoat may comprise a material of sufficiently low polarity which is unaffected by exposure to humidity or water (hydrophobic). In other embodiments, the release layer 38 may be a polar relative to the topcoat. The release layer 38 material may be made from a highly polar material such as a polymeric material which is dissolvable in a water/alcohol solution. In one version of such an embodiment, the release layer material 38 comprises a copolymer of hydroxyethylmethacrylate (HEMA) and hydroxybutylacrylate (HBA) polymerized in water and ethanol. The release layer material can be the hydrophilic or highly polar homopolymers or copolymers prepared by the methods described in U.S. Pat. No. 6,653,427 to Holguin.

The difference in polarity has to do with the relative solubility of the solvent or volatiles in the release coat materials which are coated on the top coat. The polymers which comprise the release coat material are dissolvable in a solvent which does not solubilize the top coat material, i.e., the top coat material is insoluble in the solvent for the release coat material. As a result, and in addition to their mutual adhesion, the release coat and top coat are separable along an interface which results in an absence of any significant effect on surface properties or gloss on the exposed surface of the top coat.

Alternately, the release coat 38 material may comprise a solventless resinous material which may be coated on the top coat, or on the carrier stricture 16, such as by extrusion techniques. In this instance, the two materials adhere to each other along the interface between them and separation of the release layer 38 from the top coat 18 results in no interaction or undesired effect on surface properties such as gloss of the exposed top coat surface.

The release layer 38 may be die coated or printed, by gravure printing for example, to produce a dry film thickness below about 10 microns, or below about 8 microns, and even below about 5 microns. Die coating or gravure printing of the release layer to a dry film thickness of about 5 microns or less (for example, down to a thickness of greater than about 1 micron) can provide good release or peel force levels without delamination, as described herein.

In some embodiments, the adhesion layer 40 can comprise an adhesive. In one embodiment, the adhesion layer 40 is a permanent adhesive comprising a pressure sensitive adhesive, such as that available under the designation S-8860 from Avery Dennison Corporation. The permanent adhesive material is preferably coated or printed on the carrier sheet 36 and dried on the carrier sheet 36 to form a permanent bond. The permanent adhesive is applied to the carrier sheet 36 at a dry film thickness of preferably less than about 10 microns, more preferably less than about 8 microns, and even more preferably less than about 5 microns (e.g., down to a thickness of greater than about 3 microns). The permanent adhesive layer 40 has a level of tack greater than the adhesion between the release layer 38 and the topcoat 18. The adhesion between the release layer 38 and the topcoat 18 is less than the adhesion of the surface covering component 17 to the substrate surface 20.

During processing, after the dry color layer 24 is formed on the structural layer 28, the resulting composite film then can be transported to a laminating station where the permanent PSA-coated side 40 of the releasable carrier 16 is laminated to the dry release layer 38 which has been coated on the top coat surface 18. This forms a permanent bond between the permanent PSA 40 and the release layer 38.

The release layer 38 enables the carrier structure 16 to be removed easily from the topcoat surface 18 with a desired release or peel force and produces a stable removal force over time at elevated room temperatures and pressures. In one embodiment, the release layer 38 has a Tg above about 35° C., and more preferably above about 40° C. In use, the release layer 38 provides a useful combination of: (1) adherence to the topcoat to avoid undesired premature delamination, (2) tack-free contact with the topcoat that avoids an undesired effect on surface gloss, (3) a sufficiently high initiation force to avoid undesired delamination from the topcoat surface, (4) a sufficiently low removal force to allow removal of the carrier at high or low speeds, and (5) a peel force level sufficiently lower than the PSA bond between the surface covering component and the substrate surface to prevent undesired removal of the surface covering component.

A release force lower than about 100 gm/2 inches (or per 5 cm) provides a good combination of such release force properties. The desired levels of release force can be achieved with different types of topcoat surfaces, namely, those that produce a low gloss matte finish, either by transfer of low gloss to the topcoat from a matte release carrier, or by use of particulate flattening agents contained in the topcoat material as described herein.

During use, the user can apply the multi-layer dry color laminate 10 to the substrate surface 20 by burnishing the multi-layer dry color laminate and then removing the releasable carrier structure 16. The rate of removal of the carrier structure 16 can vary among users. In some embodiments, it is desirable for the release layer 38 to produce effective low release forces for both low and high rates at which the carrier structure 16 is removed. The rate dependence of such a release layer is opposite that of removable PSAs which show a much higher release force at a higher rate of removal.

The release coat 38 material may have a relatively high initial release force compared to peel force during use. The high initial release force is desirable to prevent premature delamination. Because the release coat layer 38 has been coated on the topcoat 18 by solvent coating during processing, in the absence of PSA contact, the contact efficiency is high, which in turn produces the high initial release force.

Examples of release layer materials 38 having good stability of release force include a polar copolymer such as HEMA/HBA copolymer in proportions of 70/30 parts by weight, respectively; HEMA/HBA copolymer 65/35 parts by weight, respectively; and Copolymer 845™, PVP/DMAEMA, (polyvinyl pyrolidone/dimethyl amino ethyl methacrylate) a product of International Specialty Products of Wayne, N.J., U.S.A.), for example. Alternatively, an emulsion-type release material such as a polyvinyl acetate emulsion can be used.

In another embodiment, the release coating 38 is a polymer coating with a low melting point that can be heat laminated to the dry color component 12 instead of the use of a poly-HEMA coating and adhesive lamination. The polymer coating is applied to the carrier sheet 36 and subsequently heat laminated to the dry color component 12. Alternatively, this polymer coating can be used to extrusion laminate the carrier sheet to the dry color component where the heat from the processing of the polymer coating maintains the fluid nature of the polymer until lamination contact is made between the two substrates. The bond strength of the polymer release coating to the carrier sheet 36 must be sufficient to prevent delamination when the carrier sheet is removed after applying the surface covering component to the substrate. Analogous to the use of an adhesive lamination for the poly-HEMA coating system, a tie layer can replace the carrier adhesive layer 40 to provide this required bond to the carrier sheet. In such an embodiment, the tie layer may either be adhesion primer coated onto the carrier sheet 36 (for example, onto the non-silicone side of a PET release liner), or the tie layer resin may be coextrusion-coated with the polymer release coating onto the carrier sheet 36. The carrier sheet may also have a surface treatment (chemical or energy) to improve the adhesive bond to the polymer coating either with or without the use of an additional tie layer.

One useful but non-limiting example of the polymer release coating is a blend of polyolefins that are formulated to control the release properties during carrier sheet removal. The blends can be comprised solely of polyolefin materials such as low density polyethylene to produce a very low polarity coating. The release force can be increased by the addition of lower melting point polyolefins, such as plastomers, to the overall blend. The melting point for low density polyethylene can range from about 100 to 125° C. The melting points for the “additives” can range from about 60-100° C. Without wishing to be bound by theory, it is believed that the lower melting point materials provide better fluid contact with the dry color component surface for a given set of lamination conditions. These low melting point polyolefins are generally softer and have lower crystallinity. The polyolefin release coating blends can also incorporate polyethylene copolymers to not only reduce the crystallinity of the blend but to increase the polarity as well. The copolymerization of ethylene monomer with polar monomers such as vinyl acetate or methyl acrylate provide various grades, based on percent comonomer, that make compatible blends with the base low density polyethylene resin. The overall polymer release coating blend composition can be adjusted to again raise the release force through the fluid contact to the dry color component surface as well as the chemical interaction in the interface with these more polar components. In other embodiments, blends of more than two components could be used. These types of polyolefin blends form a “heat-activated polymer blend” system for use as a release coating.

The carrier structure 16 is heat laminated to the dry color component 12 at a temperature of about 275° F. to 325° F. (135° C. to 163° C.) with sufficient pressure to bond the carrier structure 16 to the dry color component 12. The heat-activated polymer blend layers are typically about 0.3 to 0.7 mil (8 to 18 microns) thick, and may be about 0.5 mil (13 microns) thick. The gravure-coated polyether imide (PEI) primer layers may be less than 0.1 micron thick. Several examples of such a release coating 38 along with suitable tie layers, and method of application of the same are set out in the table below.

Heat-Activated Polymer Blend Release Coatings

| | | Tie Layer/Application |
|---|---|---|
| Example | Heat-Activated Polymer Blend | Method |
| I | 2%-5% of VA (vinyl acetate) | 26% VA content EVA |
| | composition in a | applied by coextrusion |
| | LLDPE/EVA blend | |
| II | LLDPE with up to 50% ethylene | PEI based primer coating |
| | hexene copolymer | applied by gravure |
| | plastomer in a blend | |
| III | LDPE with up to 50% | PEI based primer coating |
| | Plastomer (Ethylene | applied by gravure |
| | hexene copolymer) in | |
| | a blend | |
| IV | 2-10% of MA (methyl acrylate) in | 26% VA content EVA by |
| | a LLDPE/Ethylene methyl | coextrusion |
| | acrylate copolymer blend | |

The coextruded structure in these Examples has a total thickness of about 0.5 mil and the layer thickness ratio of 1:1. The resulting carrier structure may have release force of between about 40-90 g/2 inches (or per 5 cm) at a 300 inch per minute (7.6 m per minute) test speed, and preferably a force of between about 60-70 g/2 inches under the same conditions.

The release system separates the release properties of the releasable carrier structure from gloss transfer to the dry color component. In a prior embodiment of a surface covering component containing a matte release carrier on which the different layers of the surface covering component material were cast and dried, gloss and release properties are interdependent. Those properties are separated by the release system described herein in which gloss control and color/appearance properties are controlled by the composition of the topcoat and the underlying color layers; whereas release properties are independently controlled by the present release layer, with no interactions between release from the dry color film and control of gloss in the exposed surface covering component once the carrier structure is removed.

In another embodiment, the release layer system comprises a pressure sensitive adhesive (PSA) that is coated or printed onto the carrier sheet 36 to form the overall carrier structure 16. The PSA coated surface of the carrier structure 16 is then laminated to the topcoat surface of the dry color component to complete the multilayer dry color laminate. In one embodiment, the PSA may be comprised of externally cross-linked acrylic emulsions. The functional properties including the tack of the PSA can be adjusted through the degree of cross linking and/or the coat weight of the PSA applied to the carrier sheet. Such a PSA preferably bonds to the removable carrier and contacts the topcoat material with the same level of release efficiency described above for the release coat 38.

The release force for the PSA release layer system is rate dependent and will increase with the speed of removal of the carrier sheet. This rate dependence provides for a relatively low initiation force for peel that can aid in the removal of the carrier structure 16 from the dry color component 12. The low initiation force also requires that the magnitude of this removal force be sufficient to prevent undesirable premature delamination of the carrier structure from the multi-layer laminated article before the article is completely burnished onto the substrate surface. This premature delamination can potentially occur during: the process of manufacturing the article; the application of the article to the substrate surface; or, during the burnishing of the article to the substrate surface. A release force measured at a rate of 300 inches (7.62 m) per minute for the PSA release layers when at levels of 100 grams per 2 inches (5 cm) as described above may be subject to premature delamination issues during manufacturing and handling. The release force can be raised to levels above 200 grams per 2 inches or preferably above 300 grams per 2 inches to prevent this undesirable delamination. The higher release forces make the removal of the liner more difficult at higher removal rates, but the rate sensitivity of the PSA release system enables easy low speed removal initiation to occur even with release forces measured at 300 grams per 2 inches at a rate of 300 inches per minute.

The release force for the PSA release layer system can have the tendency to increase over time as the contact between the PSA and the topcoat increases. The low initial tack (green strength) between the PSA and the dry color component may require the use of higher tack PSA formulations or delays in manufacturing for the necessary adhesion build to prevent premature delamination during the manufacturing process. One way to reduce the need for these compensating actions is to use heat lamination for bonding the PSA to the surface of the dry color component. The combination of heat and pressure during the lamination process provides better wetting of the PSA to the top coat surface with the lower tack PSA formulations and obviates the need for higher tack formulations or delays for adhesion build. The heated lamination process also provides for less change (increase) of adhesion from the PSA over time in completed rolls of the multi-layer laminate.

The carrier sheet 36 has an adhesive release coat layer 42 on the surface facing away from the dry color component 12. The adhesive release coat layer on the opposite side of the carrier sheet may comprise any release coating composition known in the art. Silicone release coating compositions may be used. To aid in burnishing or smoothing the multi-layer laminate onto the substrate surface, it may be desirable for the adhesive release coat 42 to provide sufficient surface properties to allow burnishing with tools such as squeegees or brayers without excessive slipping.

Properties

It may be desirable for the articles (that is, the multi-layer dry color laminate) 10 to be provided with certain overall properties. The articles are not required to have one or more of these properties unless such properties are included in the appended claims. These properties may be useful in providing the articles with a virtually seamless and paint-like appearance. All properties are measured at 23° C. and 50% RH.

Thinness

The portion of the dry color laminate applied to the substrate surface (i.e., the topcoat, patterns or print coats, color layer, structural layer, and adhesive), the surface covering component 17, is preferably relatively thin to minimize visible seams if adjacent surface covering components are overlapped during application.

The overall thickness of the surface covering component 17 as applied to the substrate surface in its finished state (omitting the carrier) is preferably less than about 3.3 mils (about 84 μm), and may be: less than about 2.0 mils (about 50 μm), less than about 1.6 mils (about 40 μm), less than 1.3 mils (about 33 μm), less than or equal to about 1.25 mils (about 32 μm), or even less than or equal to about 1 mil (about 25 μm). Suitable ranges of thickness of the surface covering component include but are not limited to the following ranges: from about 0.5-2 mils (from about 13-50 μm), or from about 1-2 mils (from about 25-50 μm), or from about 1 to 1.5 mils (from about 25-38 μm). or from about 1 to less than 1.3 mils (from about 25 to less than 33 μm).

The multi-layer laminate can have any suitable overall thickness. Suitable ranges of thickness of the multi-layer laminate, or any major components thereof can be obtained by adding the ranges specified for the sub-components thereof. In certain embodiments, the multi-layer laminate has a total thickness from about 32 to about 80 microns (1.25-3.2 or 3.3 mils). The thicknesses of the major components of the multi-layer laminate (the dry color component, the adhesive, and the carrier structure) are measured using a caliper manufactured by Mitutoyo Corporation Model Id #C112CEB equipped with a point (#900032, Nelson Precision) under a confining load of 8.74 grams. The thicknesses of the individual layers can be measured from photomicrographs of cross-sections of the multi-layer laminate.

Opacity

The surface covering component may provide good opacity and coverage by application of a single sheet thereof, providing consumers with cost and time benefits. Preferably, the surface covering components exhibit an opacity index of at least about 0.95 as measured according to ASTM D2805. Typically, in such measurements, the surface covering component is carefully applied on a test surface, for example the surface of a color contrast card such as a Leneta opacity form 2A, avoiding bubbles and wrinkles. In more specific embodiments, the surface covering components exhibit an opacity index of at least about 0.98, and more specifically at least about 0.995 as measured according to ASTM D2805. Substantially complete coverage, i.e., full hide, may be obtained even over dark surfaces, stained surfaces and the like.

Extensibility, Flexibility, and Conformability

Extensibility

The surface covering component may desirably exhibit at least a minimum level of extensibility, sufficient to allow bending, rolling, or similar manipulations of the surface covering component. The level of extensibility of the surface covering component will depend on the components included therein, and in particular the type of structural layer used, as well as the rate of extension.

The surface covering component may have an extensibility that may range from greater than or equal to about 0.1%, to less than about 100% (and in some cases, not equal to 100%). The surface covering component may have an extensibility in any narrower range that is encompassed within the above range, such as from greater than or equal to about 1%, or greater than or equal to about 10% to less than or equal to about 50%.

In one embodiment, the surface covering component may have a relatively low degree of extensibility and be either substantially non-elastic, or non-elastic, at room temperature. For example, when the structural layer comprises a PET film, the surface covering component (without any removable carrier) may have an extensibility of between about 0.1% to about 5%, or from about 0.5% to about 1%. In some cases, these extensibilities may be measured at a pressure of 5 psi. (3.4458×10⁴ N/m²). When extensibility measurements are specified herein as being measured at a pressure, these measurements are made according to the “Bubble Test”, which is designed to simulate in use conditions (i.e., application pressures). Otherwise, the extensibility properties described herein are measured using a modified version of ASTM-D-638M on an Instron tensile testing machine.

The surface covering component may have a tensile strain at break measured using an Instron tensile testing machine of less than or equal to about 45%, or alternatively between about 30% to about 40%. The surface covering component may have a tensile modulus of greater than or equal to about 300, 400, 500, or 600 MPa. The surface covering component may have a tensile stress at break of greater than or equal to about 12, 15, 20, 30, 40, or 50 MPa. The extensibility properties described herein as being obtained on the Instron machine are measured using a modified version of ASTM-D-638M using an Instron Model 5542 tensile testing machine. Modifications are made to the dimensions of the samples, and to the elongation rate. The sample is a dog bone-shaped sample having a neck region (i.e., extension-focused region) with a length of 0.5 inches (1.3 cm) and a width of 0.125 inches (3.2 mm). The sample is elongated at 40% strain/second strain rate.

As described herein, micro conformability of the surface covering component refers to its ability to deliver a texture that closely conforms to an underlying paint roller type texture and is consumer preferred as it delivers a uniform, paint-like appearance. Burnishing of the laminate 10 during application to a surface is a factor in achieving good micro conformability and a uniform end appearance. Since consumers may burnish with different forces and rates, they may experience different levels of final micro conformability which would detract from the desired overall uniform, paint-like appearance. There exists a need to provide an article for applying color to a surface which is less dependent on rate and pressure of burnishing. As described herein, the multi-layer laminate may comprise such an article even though it may comprise a relatively rigid, semi-crystalline engineered thermoplastic structural layer.

The articles comprising thermoplastic film structural layers can be less strain rate dependent than previously-described articles comprising plasticized PVC films. This means that the final level of micro conformability may be achieved while being less sensitive to changes in application speed or pressure.

In certain embodiments, it may be desirable for the tensile modulus of the surface covering component to remain relatively unaffected by elongation rates ranging from 4% strain/second to 40% strain/second. For example, it may be desirable for the difference in tensile modulus at these different rates to be less than or equal to one of the following amounts: 6×, 5×, 4×, 3×, 2×, 1.5×, or 1.25×. It may be desirable for the difference in tensile strain at break at these different rates to be less than or equal to one of the following amounts: 1.5×, 1.4×, 1.3×, or 1.25×. It may be desirable for the difference in tensile stress at break at these different rates to be less than or equal to one of the following amounts: 1.5×, 1.4×, 1.3×, 1.25×, or 1.2×.

The surface covering component in certain embodiments, particularly those which have a relatively low degree of extensibility, may exhibit relatively low stress relaxation. The stress relaxation of the surface covering component herein is measured using a TA Model RSA-III rheological instrument obtained from Rheometrics Scientific, which is now owned by TA Instruments of New Castle, Del., U.S.A. The sample used is one which has any removable carrier removed therefrom. Two samples are obtained. Both samples have dimensions of 14 mm×12 mm. The first sample is taken from the article with the longer dimension measured in the direction of the longer dimension of the product, e.g., the direction a rolled product unrolls (typically the machine direction during manufacture of the product (or MD)), and the second sample is taken with the longer dimension measured perpendicular thereto (in the cross-machine direction (or CD)). This is a constant strain measurement. The sample is ramped to 1% strain in 0.1 seconds. This is followed by monitoring the stress decay for up to 5 minutes. In certain non-limiting embodiments, the paint/adhesive combination component may exhibit stress relaxation in any of the following amounts at 1% strain after 5 minutes: less than or equal to about 75%, 60%, 50%, 40%, 30%, 20%, or 10%.

The surface covering component in certain embodiments, particularly those which have a relatively low degree of extensibility, may exhibit a relatively low permanent set. Thus, the surface covering component will have a low tendency to retract. This will allow it to conform to the substrate surface and stay in conformity with the substrate surface. The permanent set of the surface covering component herein is measured according to the “Bubble Test”.

The Bubble Test is performed on a Bubble test device 50 as shown in FIG. 4. The Bubble test device has a platform 52 upon which a sample is placed, and an orifice 54 in the platform that is 0.9 inches (2.3 cm) in diameter through which pressurized air is supplied. For the Bubble Test, a sample measuring 2.5 inches×2.5 inches (6.4 cm×6.4 cm) is used. The sample has any removable carrier removed therefrom. The sample is placed on the surface of the platform 52 over the orifice. A cover 56 is placed over the sample. The cover is fastened to the platform by screws 58 that fit into four holes 60 in the platform 52. The screws are tightened to make sure device is air tight and during the measurements. There is a hole 62 in the center of the cover 56 that is ¼ inch (6.3 mm) in diameter. When pressurized air is supplied to the sample, a portion of the sample may rise up through the hole 62 in the center of the cover 56.

The Bubble Test involves subjecting a portion of the sample to air pressure from the underside in step-wise increasing amounts of 1, 2, 3, 4, and 5 psi. (6.895×10³, 1.379×10⁴, 2.069×10⁴, 2.758×10⁴, 3.4458×10⁴ N/m²), and then decreasing the air pressure in step-wise amounts of 5, 4, 3, 2, 1, and 0 psi. The portion of the sample that is subjected to air pressure is 2 inches (5 cm) in diameter. The height of the top surface of the inflated bubble above the surface of the remainder of the sample is measured at each air pressure increment. The permanent set is calculated as the ratio of the bubble height after it is deflated to 0 psi. to the bubble height at 5 psi. In certain non-limiting embodiments, the surface covering component may exhibit a permanent set of greater than or equal to about 0.1% or 0.5%. In certain non-limiting embodiments, the surface covering component may exhibit a permanent set of less than or equal to about any of the following amounts: 50%, 40%, 30%, 20%, 10%, 5%, 2%, 1%, or 0.5%. In certain non-limiting embodiments, the surface covering component may exhibit a permanent set in any suitable range including, or between, the above sets of minimum and maximum values.

Flexibility

The flexibility of the articles described herein is determined by measuring their bending stiffness and rigidity.

Bending Stiffness

Bending stiffness is measured using a Testing Machine, Inc. (Ronkonkowa, N.Y., U.S.A.) bending tester model K-416. The test procedure conforms to ISO 2493. The product to be tested includes any removable carrier thereon. Two 1 inch by 1.5 inch (25 mm by 38 mm) rectangular samples are cut from the product with the 38 mm (width) cut perpendicular to the test orientation of the product, e.g., cut 38 mm in cross direction (CD) for sample testing in the machine direction (MD). One sample is placed in the bending tester with the 38 mm width oriented vertically. The tester is set so that the bending angle is 15 degrees and bending length is 5 mm. The same test run with the second sample oriented horizontally, and the values are averaged to obtain an average of bending stiffness in the machine direction (MD) and cross-machine direction (CD). The bending resistance force of the sample is measured by this instrument.

The bending stiffness of the sample can be calculated with the following equation:

Stiffness (mN)=8.376 10⁻⁴×Bending Resistance Force (mN)

The articles described herein may have any suitable bending resistance, such as a bending stiffness of greater than or equal to about 10 milli Newton (mN), and less than or equal to about 20 mN, 25 mN, 30 mN, 35 mN, 40 mN, 45 mN, or 50 mN. In certain embodiments, for example, the articles may have a bending stiffness of between about 10-20 mN, alternatively about 15-20 mN.

Rigidity

Rigidity is measured using a Thwing-Albert Handle-O-Meter available from Thwing-Albert Instrument Company, West Berlin, N.J., U.S.A. The test is performed according to ASTM D6828-02. A 2 inch by 2 inch (5 cm by 5 cm) square sample is cut from the product. Samples can be tested both with, and without any carrier on the same.

The articles described herein may have any suitable rigidity. For good conformity, it may be desired for the articles to have a rigidity without any carrier of less than or equal to about 1 g/cm, or less than or equal to about 0.8 g/cm (for example, from about 0.1 to about 1 g/cm, alternatively from about 0.3 to about 0.7 g/cm). The articles may have a rigidity with a carrier of less than or equal to about 20 g/cm, 15 g/cm, or 13 g/cm (for example, from about 4 to about 13 g/cm, or alternatively, less than or equal to about 10 g/cm). In some embodiments, the rigidity with the carrier may be greater than about 4 g/cm.

Conformability

The surface covering component may also exhibit sufficient conformability to adapt to the topography/surface morphology of the surface to be colored. In addition, the surface covering component may be sufficiently conformable to allow the articles to be easily manipulated around and/or into corners and other three-dimensional configurations. Further, the sheet of the surface covering component may be micro-conformable. As used herein, micro-conformability refers to the ability of the articles to become similar in form or character to the surface to which they are adhered, whereby, upon application, both inner and outer surfaces, 17A and 17B, respectively, of the surface covering component will mimic the texture of the underlying surface to provide a paint-like appearance.

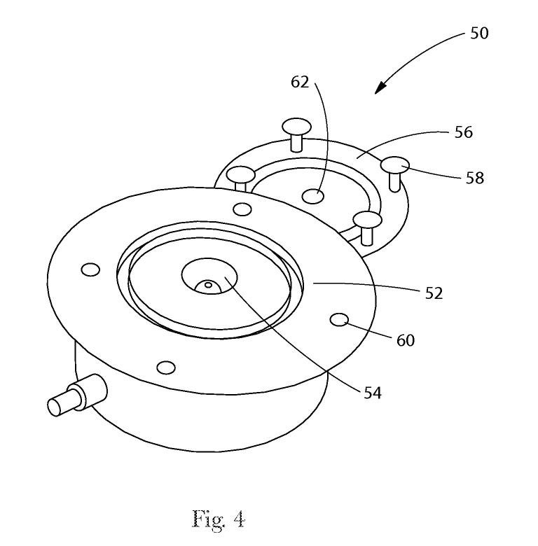

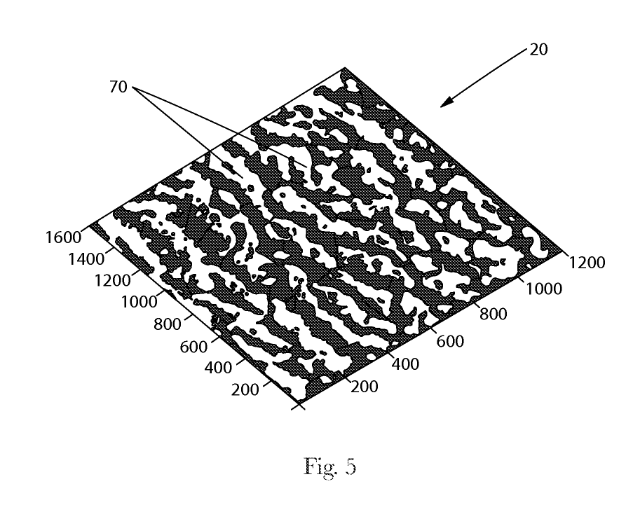

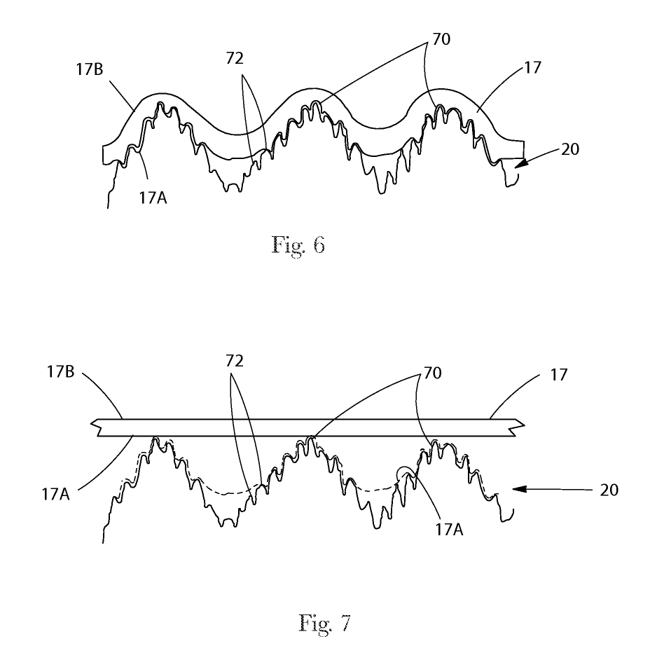

Specifically, in the case of application to interior walls, it has been found desirable for the surface covering component 17 to be sufficiently conformable to conform to the texture left by a paint roller in applying paint or primer to an underlying surface, for example drywall. Drywall is used as an example of a typical surface but is not intended to limit potential suitable surfaces. FIG. 5 shows one example (enlarged) of the surface texture of a section of primed and painted U.S. drywall material 20. As shown in FIG. 5, the surface of drywall has a plurality of irregular rugosities 70 thereon. These are shown in schematic cross-section in FIG. 6. As shown in FIG. 6, the surface of the drywall 20 comprises the rugosities 70 (three of which are shown), which may be considered to define the visible, or “macro” surface roughness of the painted drywall. FIG. 6 also shows that each of these rugosities has micro-rugosities 72 thereon (which can only be seen under magnification). The micro-rugosities 72 may be considered to define the micro roughness of the surface 20.

FIG. 6 shows an example of the outer surface 17B of a surface covering component 17 that deflects to achieve a degree of micro-conformability with the surface 20 of the painted drywall material. The term “micro-conformability”, as used herein, refers to at least partial conformability to the visible rugosities 70 as opposed to bending around corners, and the like (which relates to “conformability”); it does not require conformability to the micro-roughness 72 of the surface.

As shown in FIG. 6, it is not only desirable that the inner surface 17A of the dry color component 17 at least partially conform to the texture of the underlying surface 20 to which the dry color laminate is adhered, it is also desirable that the outer surface 17B also at least partially conform to (or follow) the texture of the underlying surface 20. As shown in FIG. 6, perfect conformity to the texture of the underlying surface is not necessary, however. Thus, it is not necessary that the inner surface 17A of the dry color component 17 conform exactly to the rugosities 70, or to the micro-rugosities 72 for an article to be considered micro-conformable. FIG. 6 can be contrasted with FIG. 7 which shows an example of a surface covering material 17 that achieves relatively poor conformability with the underlying dry wall material.

It has been found that consumers do not prefer articles which are not able to deliver micro-conformability as described above. Consumers believe that articles that are not able to deliver this level of conformability look more like a large piece of adhesive tape on the wall, rather than a dry paint. Typically, for a previously painted drywall surface, the surface texture resulting from roller paint coating has a roughness value (Ra) of 5-10 microns with a maximum peak to valley heights of 30-50 microns and spacing of major peaks of several millimeters. If an applied surface covering component bridges these peaks, it changes the overall appearance of the wall texture in a negative way. This is the case even if the surface covering component 17 has an inner surface 17A (but not an outer surface 17B) that conforms to the rugosities 70 such as is shown in dashed lines between the second and third rugosities 70 in FIG. 17A. Such a structure having an inner surface 17A that achieves micro-conformability, but an outer surface 17B that does not, would be suitable for a film applied to an automobile body to provide a smooth exterior appearance, but would not provide the desired paint-like appearance for interior drywall surfaces.

A test procedure for measuring conformability and micro-conformability is as follows. Sample sheets of the article measuring 4 feet (1.2 m)×1 foot (0.3 m) are applied to the surface of a piece of primed and painted U.S. dry wall material. The sample sheets are then visually assessed by ten panelists and graded numerically against the following scale. In the following table, in grading uniformity of the conformability, the term “patches” refers to areas of the article which are substantially free of texture from the underlying dry wall material.

| Rating | | |
|---|---|---|
| Scale | Micro-Conformability | Uniformity |
| 0 | Totally floating/detached | Very well defined patches |
| 2 | Slight texture | Large patches |
| 4 | Texture, but different than | Small patches |
| | wall | |
| 6 | Can clearly see wall texture | Some patchiness |
| 8 | Very close to wall texture | Very slight patchiness |
| 10 | Perfectly following wall | Completely uniform across |
| | texture | sheet |

The conformability and micro-conformability are preferably exhibited at room temperature as defined above. It is desirable that the article have an average micro-conformability score of at least 6. It may also be desirable that the article have an average uniformity score of at least 6. Without wishing to be bound by any particular theory, the properties which are believed to provide the surface covering component with the desired conformability are its flexibility as defined by its bending stiffness and rigidity, along with at least the minimal level of extensibility described above. If the surface covering component has these properties, it may exhibit the desired level of conformity, even if it is provided with a relatively stiff and relatively inextensible structural layer.

Conformability can also be expressed in terms of sensory data that measures the extent to which the surface covering component 17 looks and feels like paint on a surface such as a wall.

The following test procedure is for measuring the extent to which the multi-layer dry color laminate looks and feels like paint on a surface. Two sheets of the article to be tested are applied to the surface of a piece of primed and painted U.S. drywall material. The sheets are applied in the manner directed by the manufacturer, and are applied so that any seam formed by the application of the sheets runs down the center of the drywall material. The drywall material is cut into a panel which measures 1 foot (0.3 m)×1 foot (0.3 m), keeping any seam in the center of the panel. Four comparison samples are prepared on surfaces of similar primed (but not initially painted) U.S. drywall material panels. The comparison samples comprise: (1) a panel painted with interior wall paint having a satin gloss level; (2) a panel painted with interior semi-gloss wall paint; (3) a panel painted with a faux finish using a metallic paint applied with a sponge; and (4) a panel painted with a faux finish using a faux combing tool. The samples are then assessed by twenty panelists. For the “Looks Like Paint” assessment, the samples are compared visually. For the “Feels Like Paint” assessment, the panelists are blindfolded, and the panelists compare the samples by feeling the surfaces of the same. The samples are then graded numerically against the following scale.

| Rating | | |
|---|---|---|
| Scale | Looks Like Paint | Feels Like Paint |
| 1 | does not look like paint at all | does not feel like paint at all |
| 2 | slightly looks like paint | slightly feels like paint |
| 3 | somewhat looks like paint | somewhat feels like paint |
| 4 | very much looks like paint | very much feels like paint |
| 5 | extremely looks like paint | extremely feels like paint |

The material being tested against the comparison samples preferably achieves a score of 3 or better on at least one of the “Feels Like Paint” and “Looks like Paint” scales. In another way of evaluating the extent to which the material being tested feels or looks like paint, the material preferably scores within 1 point, more preferably within ½ point of the painted surfaces on the “Feels Like Paint” and “Looks Like Paint” scale.

One possible use of the multi-layer dry color laminate is as a surface covering for interior architectural surfaces. Therefore, it is desirable for the surface covering component to exhibit dimensional stability. That is, the surface covering component should be substantially insensitive to changes in heat or moisture and should not substantially expand or contract after application on the wall. Dimensional instability may be exhibited as the surface covering component lifting up from corners, expansion or contraction at seams or overlapped areas, or shrinkage in the z-direction. Such dimensional instability can lead to an undesirable appearance and detract from the desired virtually seamless, paint-like appearance of the applied laminate. The inclusion of a structural layer with a relatively high modulus and low moisture sensitivity can provide the surface covering component with dimensional stability while maintaining other desirable features such as micro conformability and rigidity.

Gloss

Gloss for the articles described herein, is measured by specular reflectance of a beam of light at angles of 60° and 85°. Typically, the specular reflectance for the surface covering component is less than, or less than or equal to, any one of the following: about 60, 50, 40, 30, 20, 10, or 5 gloss units at 60°. A lower limit may be about 1 gloss unit at 60°. The specular reflectance for the surface covering component may be less than, or less than or equal to, any one of the following: about 60, 50, 40, 30, or 20 gloss units at 85°.

In one embodiment, the surface covering component has a specular reflectance of between about 1-6, alternatively between about 3-6 gloss units, or alternatively less than 5 gloss units at 60°. Such an embodiment may have a specular reflectance at 85° of: between about 3-60 gloss units, alternatively between about 3-50 gloss units, alternatively less than 20 gloss units, alternatively, between about 3-20 gloss units, alternatively, between about 10-20 gloss units, or alternatively between about 12-15 gloss units. In one embodiment, a non-filled topcoat can be embossed to produce a surface covering component with a specular reflectance of 2 gloss units at 60° and 5 gloss units at 85°.

One of ordinary skill in the art will appreciate the difference between such finishes and high-gloss finishes such as are employed in, for example, the automotive industry. Specular reflectance may be measured using the test method described in General Motors Test Specification TM-204-A. The Byk-Mallinckrodt “multi-gloss” or “single gloss” gloss meters can be used for measuring specular gloss of the finished surface. Those gloss meters give values equivalent to those obtained from ASTM Method D-523-57. Further details on the specular reflectance measurements are disclosed in U.S. Patent Application Publication No. US 2004/0200564 A1.

Discoloration Barrier Properties

The structural layer, in some embodiments, may provide discoloration prevention properties as described in U.S. Patent Application Publication No. US 2005/0196607 A1. In certain embodiments, the structural layer provides a barrier to discoloration-causing pigments characterized by producing a color shift of no more than 0.40 Δb* C.I.E. color units at 60° C. for at least 400 hours.

Force Balance

The components of the dry color laminate may be provided with differential release properties between the layers thereof as described in U.S. Patent Application Publication No. US 2005/0003129 A1. However, in the case of the multi-layer dry color laminate described herein, the carrier structure release force at normal removal rates (from 10-1000 inches/min (25-2,500 cm/min.), or 12-300 inches/min (30-760 cm/min.)) may be lower than the roll unwind force, provided that the force to initiate carrier structure release is sufficiently high to prevent premature delamination during processing or application to the wall. Further, it is desired that the force to initiate carrier structure release is lower than the adhesion force of the product to the wall, so that the carrier structure may be removed without lifting the applied product.

It is further described in U.S. Patent Application Publication No. 2006/0051571 A1, that the product adhesive forces must balance during application and repositioning of the product on the wall. An advantage of the current product construction is that the product applied to the wall, after removal of the carrier structure, has high modulus and low extensibility. Thus, when a second film is applied at an overlap and needs to be repositioned, the first film has a low tendency to stretch, and consequently the second film can be removed without the first film deforming and lifting from the wall.

Water Vapor Transmission Rate

The articles and methods may be employed to provide a porous surface covering component which allows air to escape as the article is applied to a surface, thereby avoiding bubbles and/or wrinkles from appearing on a covered surface. In certain embodiments, the surface covering component is microporous and therefore allows moisture to escape rather than accumulating between the applied article and a surface to which it is applied. For example, the surface covering components provided by the articles and methods described herein may, in certain cases, exhibit a water vapor transmission rate (WVTR) of greater than about 0.1 g-μm/cm²/24 hrs, or greater than about 1 g-μm/cm²/24 hrs, or greater than about 4 g-μm /cm²/24 hrs, at 100% relative humidity and 40° C., as measured according to ASTM F1249-90. The desired WVTR may be provided through the use of materials which inherently allow water vapor transmission and/or by providing pores, perforations, orifices or the like in the articles, either on a micro or macro scale.

Color Uniformity and Print Quality

Since in certain embodiments, the articles are designed to be overlapped and patchable, the quality of printing and uniformity of color may be important so that overlapped areas and patched areas are not readily visible. The term “patchable”, as used herein, refers to a graphic that is capable of having a portion of any size of that graphic copied and overlayed onto the original graphic in any position, and the appearance of the composite graphic is such that the overlayed portion (or patch) is not visually distinguishable from the bulk of the graphic, or the original graphic. Control of color and uniformity may be much more important than in other applications such as packaging or labels where such articles may be separated by distance on a shelf or distributed to multiple customers who will not notice relatively large changes in color. To this end, color control of inks (e.g. density, color) and control of printing defects (e.g. smears, streaks, gaps in coating, variations in coat weight) need to be more carefully managed during processing.

In conventional printing such as gravure, custom colors, referred to as “spot colors”, may be blended to create the color portion of the article. In various printing processes, especially in digital printing processes, colors can also be created by combining various ratios of cyan, magenta, yellow, and black inks and depositing such color marking material on the substrate to be printed. As these colors are relatively intense, small variations in these colors can cause relatively large variations in the color of the article.

One method of reducing the effect of this variation is to tint the substrate to be a similar color to the overlying digital print. This may have several benefits. First, any missing print areas (e.g. from blocked print nozzles) will have the background color and the defect will not be as obvious as if the printing was on a white background. Second, the amount of digital ink may be reduced. For example, a high coverage red color requires large amounts of magenta and yellow ink. If a significant portion of the red color is provided by the substrate, the digital printer needs to provide a relatively small amount of ink to customize the color and pattern. Using a tinted substrate may, for example, result in a savings of 10%, 20%, 30%, or more, of the amount of color marking material required in the digital printing process on tinted web in comparison to the same process which involves printing on a white web instead of a tinted web. This provides both operational and financial benefits since gravure inks are typically significantly less expensive than digital inks. In addition, printing with lower amounts of ink may yield more stable color control through the printing process since the printing press is not forced to operate at the upper range of its capability.

Tinted or colored substrates may also help to reduce print variation in cases where the underlying color is substantially similar to the overlying color to be applied. The color of the underlying tinted layer may depend on the color or opacity of the inks used for printing on the tinted layer. For example, in printing applications that use non-white, non-opaque printing inks, the substrate to be printed will typically be lighter than the final printed design. In such cases, it is preferred that the reflectance curves chosen as the background color for that cluster have at least the maximum reflectance for that cluster. In cases with opaque inks or white inks, there is additional flexibility in designing the tinted layer since the overlying ink can block all or part of the underlying tinted layer color. In such cases, the substrate can be darker than the ink to be applied.

In one embodiment, tinted opacity layers may be selected for a sample set of “n” (e.g., n=50) images as follows:
1. Printed image samples are analyzed with a spectrophotometer using a 4 mm port to determine the reflectance curves for all areas in each print. The maximum reflectance from all areas, at each wavelength, defines the lightest color within the design and is presented as (% reflectance from 400-710 nm).
2. The reflectance curves of these areas are clustered based on hierarchical analysis with JMP software available from SAS Institute, Inc. of Cary, N.C., U.S.A., to select a plurality of clusters. In one example, clusters range in number from 6 to 48. In theory, any number of clusters, from 1 up to the total number of curves can be used.
3. Based on the analysis in step 2, a plurality of tinted substrate colors, including white, are selected for the set of n images. The tinted substrates can be selected so that one tinted substrate can be used for two or more different images. For example, rather than a manufacturer having to stock 50 different tinted printing substrates for 50 images, the manufacturer can stock any suitable number between 2 and 50 different color tinted webs. Thus, a manufacturer of multi-layer laminates with “n” different images may only need to stock between about 5% to about 30% of “n” different color tinted webs.

It has been found that the reduction in dE* with respect to the desired target image is generally higher with darker or heavier printed colors, when compared to multi-layer laminates having white opacity layers.

Pattern and Color Design

The element design and colors used within a pattern may influence the performance of the article when it is applied to a substrate surface and the manufacturability of the printed article. As used herein, “performance when applied to a substrate surface” is used to describe both the ability to mask the appearance of seams or overlapped areas when applied to a substrate surface and the ability to minimize the noticeability of potential color or appearance differences. As used herein, “printability” is used to describe the ease of achieving the desired print quality (e.g. the ability of the product to mask potential printing defects).

Random patterns may be used to reduce the perceptibility of seams. Random patterns may be made in a variety of ways, including randomizing discrete or amorphous design elements. It is generally found that the more visual noise (i.e. inherent variation) there is within the pattern, the better it performs at reducing the perceptibility of seams or print defects. For example, visual noise may be increased by using more colors (e.g. shades of the same color) or by using markedly different colors.

Defects that influence printability will vary based on the printing technology. For example, a digital electrophotographic printer may have issues with side-to-side color uniformity due to variations in flow of powdered toner across the printed web or to other transfer steps used in building the image. Alternatively, a digital inkjet printer using liquid inks with multiple inkjet heads in a fixed array may have issues with head-to-head color uniformity. It has been found that image design features can be correlated to the degree of printability. For example, with a multi-head inkjet printer, the printability of an image can be estimated by modeling the lightness and the variation or complexity within the image. A more thorough but more complex model may incorporate the scale of the pattern. A similar analysis can be done on images to predict performance when applied to a substrate surface.

The laminates described herein, and components thereof, may also be formed of any of the materials, or be provided with any of the properties, components, or have any of the layer arrangements described in the following patent publications: U.S. Patent Application Publication No. US 2003/0134114 A1; U.S. Patent Application Publication No. US 2004/0076788 A1; U.S. Patent Application Publication No. US 2004/0200564 A1; U.S. Patent Application Publication No. US 2006/0046027 A1, US 2006/0046028 A1, and US 2006/0046083 A1; U.S. Patent Application Publication No. US 2006/0051571 A1; U.S. Patent Application Publication No. US 2004/0253421 A1; U.S. Patent Application Publication No. US 2005/0003129 A1; U.S. Patent Application Publication No. US 2005/0196607 A1 on Sep. 8, 2005; and U.S. Patent Application Publication Nos. 2008/0081142 A1 and 2008/0078498 A1.

Methods of Applying Color to a Surface

The multi-layer dry color laminate 10 may be used by unrolling it from the roll (that is, if it is in roll form). In one embodiment, the multi-layer laminate is simultaneously unrolled and applied to the substrate surface. The multi-layer laminate is placed on the substrate surface with the adhesive 14 in contact with the substrate surface 20. The multi-layer laminate 10 is particularly suited for applying to a wall under room temperature conditions. The multi-layer laminate may be applied to a surface by hand, or with the use of a simple applicator, for example a squeegee, wall paper roller, and/or dispenser, or other tool. Tools suitable for applying the articles are described in: U.S. Pat. No. 6,808,586 B1 issued to Steinhardt; U.S. Patent Application Publication No. US 2005/0092420 A1; and, U.S. Patent Application Publication No. US 2007/0034328 A1. The multi-layer laminate is repositioned if necessary. Once the multi-layer laminate is in its desired position, pressure is applied so that the multi-layer laminate is permanently adhered to the surface. Any pressure required for adhesion of the laminates may be applied by hand or with a tool, such as a squeegee. Such pressure may be applied in a single pass or by two or more passes over the article. The carrier structure 16 is then peeled off the front face of the surface covering component 17, leaving the surface covering component 17 adhered to the substrate by the adhesive 14. The carrier structure 16 can be peeled off the front face of the surface covering component 17 in any suitable manner, including using a tape that adheres to the carrier structure 16 to assist in removing the same. The surface covering component 17 can be smoothed down on the substrate surface by applied pressure after the carrier structure 16 is removed.

Methods of Making the Articles

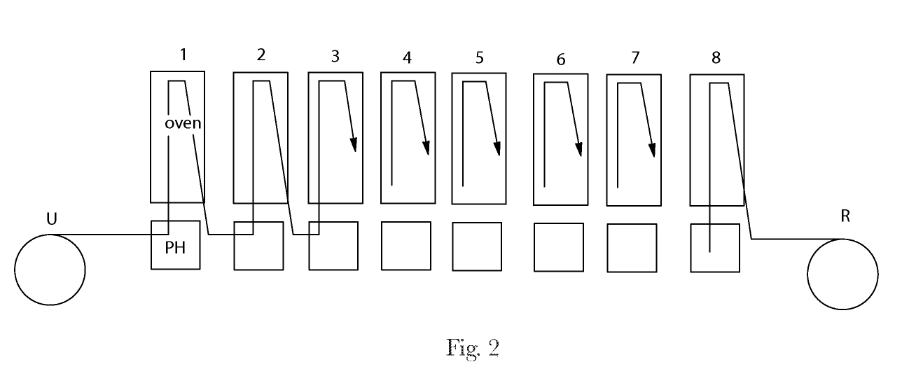

FIG. 2 is a simplified schematic of one non-limiting embodiment of a method of manufacture of one portion of the dry color component 12. There are a number of possible ways of making the dry color component 12.

Processes for making the dry color component can use any suitable inks and printing equipment. Suitable inks include, but are not limited to water-based inks, solvent-based inks, UV curable inks, heat set/thermal cure inks or other ink systems suitable to continuous tone printing. Suitable printing processes include, but are not limited to: flexographic, lithographic, electrostatic, ink jet, gravure, digital, or other processes suitable to meet the objectives of the printing process.

The process shown in FIG. 2 is generally known as a direct rotogravure printing process. The process utilizes a fluid organic solvent-based ink and a chrome coated mechanically engraved or chemically etched print cylinder, suitable to the ink being printed with respect to thickness, coverage, rheology, color and resolution. The print cylinder deposits the ink from a printing ink reservoir to the structural layer, which serves as the print substrate. Alternative gravure print cylinders may be ceramic coated, laser-engraved, or may use other alternative imaging and surfacing technologies.

In one embodiment, the ink has a viscosity in the range of 16-28 seconds as measured by a #2 Zahn cup test. The Zahn cup is widely used in the coating industry to measure viscosities of liquids. It is basically a stainless steel dip tube with a precise orifice drilled in the bottom. The user times how long it takes for fluid to empty out of the cup. This can be translated to Centipoises, or more commonly is expressed in terms of “seconds”. There are different number cups depending on viscosity ranges, #2 is a typical one. There is an ASTM standard method for the measurement. It is ASTM D 4212 Test Method for Viscosity by Dip-Type Viscosity Cups.

In one method of making, a 3.5 micron polyester film suitable for use as the structural layer is first laminated to a relatively thick adhesive transfer tape to form a laminated PET film. The lamination to the adhesive transfer tape provides stability and rigidity to enable the thin polyester (PET) film to be processed in subsequent unit operations. In an alternative method of making the multi-layer dry color laminate, the pressure sensitive adhesive (14) is first coated on a release liner, then a color layer is coated overlying the adhesive layer. This color layer may then be further processed. In this alternative method, the structural film is optional since the release liner underlying the adhesive layer can provide sufficient stability for processing through subsequent unit operations.

A rotogravure process used for making the dry color component 12 involves transporting a continuous web (e.g., of the laminated PET film) from an unwind stand U, to a rewind stand R under proper tension and tracking to position the web properly with respect to the print units in each of the eight print stations shown in FIG. 2. In other embodiments, fewer, or more, print stations can be used. The print system comprises a print head PH which prints the desired image onto the substrate and an oven which dries the ink to the desired solvent retention level. The capacity of the drying oven is related to the desired solvent retention level, the constituency of the blend of solvents used in the ink and the speed at which the process is to be run.

In one embodiment, a conventional printing process such as gravure, flexographic or rod coating is first used to apply an opacifying layer or layers to the structural layer and the remainder of the color and pattern is printed digitally. For the gravure application shown, multiple stations may be used to print white opacifying ink layers in the range of 4 to 6 grams per square meter dry basis per station. Surface treatments may be used to ensure the desired ink adhesion. Typically, two or three opacifying ink layers are sufficient to achieve the desired opacity of >99.3% in combination with the opacity of the adhesive added in subsequent processes. The two or three opacifying ink layers may be printed on the same side or on opposing sides of the PET film (of course, printing both sides would require that the adhesive transfer tape not be present on the PET film). Surface treatments may be used to ensure the desired ink adhesion irrespective of the surface on which the printing occurs.

Alternative methods of coating or alternative configurations that deliver higher coat weights per layer may be used to reduce the number of layers needed while providing the same opacity. In certain embodiments, it may be desired to tint the opacifying ink to reduce potential color variation in the digital print process used to apply the final color or pattern or to minimize the appearance of a seam after cutting the article.

After the desired number of opacifying layers are printed, the roll of opacified film is moved to a rod coater. An optional aqueous priming layer is applied at about 5 to 10 dry gsm.

After the appropriate number of opacifying layers are printed, the web is printed. The web may be printed using conventional printing processes such as those used to print the opacifying layers. Such conventional printing processes may be carried out in print units 4 and 5 to form ink layers having the specific color appearance desired. The print color layers may include a matting agent or other additives to ensure proper color and ink performance properties. The print layers may be dried and a halftone or benday print structure may be used to create a visually non-repeating graphic of suitable color and detail to meet intended use of the surface covering component. Such a graphic may require at least two separate print cylinder engravings mounted in print heads 6 and 7. Additional print heads may be used in which case the rotogravure press would be equipped with more than eight print heads.

In other embodiments, the opacified and primed web is digitally printed. Digital printing can significantly reduce the number of print stations needed. For example, digital printing may require only a single print unit (e.g., at the location of unit 4) to print a combined color and print coat. In addition, in the case of some types of digital printing, the drying ovens can be eliminated. The print platforms may be capable of continuous web printing to allow roll-to-roll printing (so that the printed web is rolled back up at the end of the process). The opacified and primed web is fed via an unwind system, printed, and rewound.

Finally, a matte topcoating is applied over the printed web. In one embodiment, a UV resin substantially free of flattening agents is applied and a textured film is used to modify the surface of the topcoat. The UV resin is first applied to the printed surface, and then the textured film is contacted with the resin. The resin is then cured using UV energy while the film is in contact with the resin. The textured film is then removed, leaving a modified topcoat surface. Alternatively, conventional gravure or similar printing operations with UV based topcoats, aqueous topcoats or solvent topcoats containing flattening agents may be used. The topcoat is designed to meet the requirements of gloss, stain resistance, scratch resistance and other physical properties needed to meet the product's intended use.

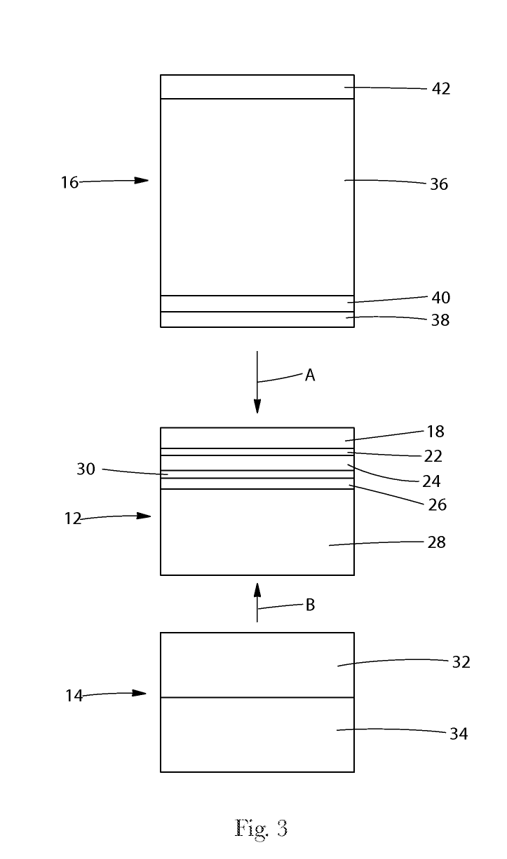

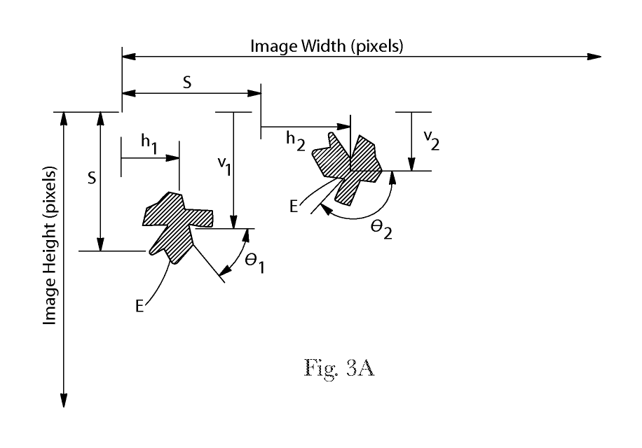

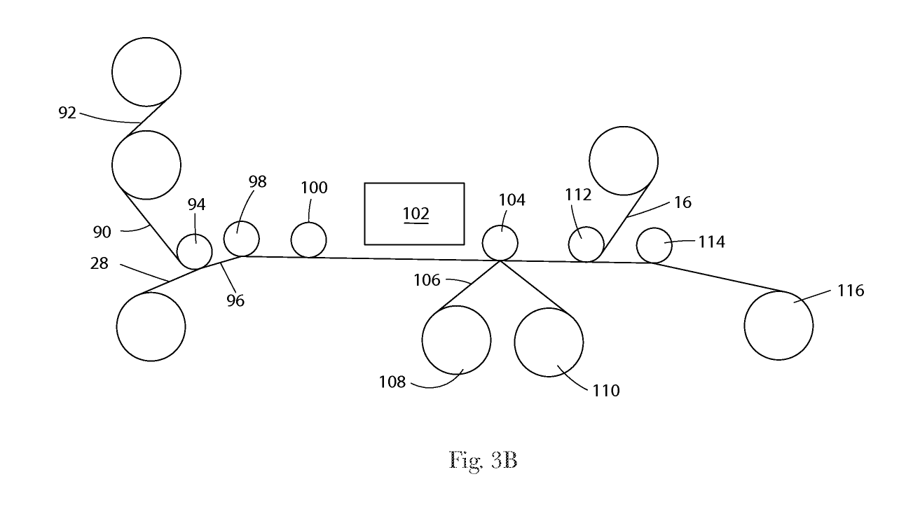

As shown in FIG. 3, the carrier structure 16 can be formed separately with an adhesive release coat 42 on one side (for engaging the pressure sensitive adhesive layer when the laminate is in roll form) and a release surface 38 on the surface that will face the topcoat 18. The carrier structure 16 can then be releasably joined to the topcoat 18. The pressure sensitive adhesive layer 14 can also be formed separately and then joined to the structural layer 28. The components may, as shown in FIG. 3, be joined in order with either step B following step A; or, with step A following step B.

The articles and methods described herein may offer manufacturing benefits. In contrast to a conventional gravure operation using multiple custom spot colors and requiring long runs to amortize the costs of setting up a press for a custom color, the digital printing operation minimizes substrate stocks. In one embodiment, only one substrate and the component cyan, magenta, yellow and black inks would be needed to provide a wide variety of patterns and colors.

Furthermore, in contrast to conventional gravure printing which uses engraved cylinders, digital printing allows the flexibility to change design and color without the cost or complexity of creating new cylinders or custom blending of inks. This is particularly useful in allowing customization and personalization of colors or patterns. In contrast to having to produce large quantities of pre-selected colors to maintain an economic order quantity, digital printing allows the flexibility to produce small amounts of customized products in an economic manner. Digital printing also allows the use of variable data (i.e. text, data, graphics, or colors can be continually changed during printing) instead of being limited to static images. In this manner, the article can be customized to match existing paint, furniture, trim, woodwork, tiles, or other interior items as desired.

In one method of making a customized article, the consumer selects one or more discrete design elements (e.g. a logo, photograph, geometric element, etc.) which may then optionally be randomized and incorporated into a design (or image) for the article. The consumer can create and/or print the design themselves, or select the design element(s) and provide the design element(s) to a manufacturer, printer, retailer, or other party, and the other party can create and/or print the final design and article with the design thereon. The consumer can select the design element(s) and/or create the design themselves such as on a computer at a retail or printing location, or on the internet such as on a website. The computer may display an x-y grid for creating the design. The design element(s) have x and y axes that can be rotated in the x-y grid. The consumer can provide the design element(s) to the other party in any suitable manner including, but not limited to sending the same to the other party by mail, or using a computer over the internet, such as on a website or by e-mail. In one non-limiting example, software such as MATLAB® by The MathWorks, Natwick, Mass., U.S.A. is used to randomize the design element. A design program such as Adobe® Photoshop® from Adobe, San Jose, Calif., U.S.A., may then be used to further modify the design element for aesthetic or functional purposes as desired. In this manner, the final combination of color, pattern, gloss, etc. may be customized to the consumer's request.

The MATLAB® program for randomizing design elements makes use of two built-in functions: (1) a function for rotating images; and (2) a random number generator. The program inputs comprise: a) the number of design elements per unit area (e.g. a 200×200 pixel area); b) the dimensions of the requested image (e.g. 1000×2000 pixels); and c) a design element image.

A randomized image or design created from a plurality smaller of non-rectangular design elements E (e.g., smaller images/designs/elements/logos) such as that shown in FIG. 3A may be created as follows. The design elements E can be modified in software such as Adobe(® Photoshop® to make everything but what is considered the design element black, with pixel value(s) of zero. The user provides the following: (1) desired image height and width in pixels, (2) sub-division size “S” for each area in which the smaller design element should appear, and (3) a digital image with the desired image/design/element/logo with everything but the desired image/design/element/logo colored black (RGB pixel values of 0, 0, and 0). The image/design/element/logo is randomly rotated and semi-randomly positioned within each of the sub-divided areas, S. Angles θ₁, and θ₂, and distances h₁, h₂, v₁, and v₂ are shown to represent the randomly generated angles and positions. The design element may be randomly rotated any number of degrees from 0 to 360 degrees. The program is used to randomly select a horizontal and vertical location within the subdivision to locate the centroid of the design element image. The process is repeated until the image is bigger than the desired image size. Areas of previously placed design elements that are overlapped by portions of the new design elements are replaced with the new design element. Any two of the design element(s) can be arranged in any suitable manner to form the image, including, but not limited to: 1) making the design elements of the same or different sizes relative to each other; 2) rotating the axes of the design elements any number of degrees relative to each other from 0 to 360 degrees; 3) arranging the design elements in any suitable density (such that the design elements comprise any suitable percentage of the area of the image (e.g., from 5% to 100%, or any percentage therebetween, e.g., 60%); 4) overlapping or placing the same in a non-overlapping relationship; and any combinations thereof. In some cases, it may be desirable to divide at least some of the design elements in half (or in some other suitable proportions) to create a pattern which has an improved ability to hide seams since at least some of the images may be divided at the edges of sheets. This will incorporate divided designs into the pattern, rather than having the same only appear at the edges. Any suitable percentage (from 0 to 100, or any percentage therebetween) of the design elements may have their axes oriented in any orientation relative to the edges of the sheets. In some cases, for example, it may be desirable for no more than 20% of the design elements to have either their x, y, or both axes oriented parallel to the edges of the sheets. The randomized image is saved in a format that allows additional modification in a graphics program such as Adobe® Photoshop®.

As a further customization step, the adhesive mentioned above may be customized for the end user. Wall finishes vary widely (e.g. drywall, flat paint, satin paint, semi-gloss, glossy paint) and adhesive performance may vary depending on the texture or composition of the substrate surface. Thus, it may be desirable to customize the performance properties of the adhesive to better match the substrate surface. It may also be desirable to custom tint the adhesive. In one method of customization, a kit or service may be provided to measure the roughness, gloss, texture, or other attributes of the substrate surface to be decorated in or order to customize the adhesive. Aspects of customization may include but are not limited to adhesive type, coat weight, color, and odor.

Although the aforementioned processes used in manufacturing the multi-layer dry color laminate are described as discrete operations, they may be combined in one in-line manufacturing system. Such a unit would be useful in producing a completely assembled finished custom order product while maintaining a small footprint for the unit. For example, rather than manufacturing large quantities in one central location, smaller self-contained units can be located in a retail location to provide “print on demand” custom print orders. Alternatively, smaller systems can be distributed across a geography to reduce shipping or inventory or to provide customized patterns or colors for a geographic area.

A simplified diagram of such an in-line system is shown in FIG. 3B. In such a system, web for the structural layer 28 (e.g., PET film) is unwound, and laminated to an adhesive transfer tape 90. Adhesive may be selected and customized based on substrate surface properties. If there is a releasable liner 92 on the adhesive transfer tape 90, it can be removed and wound. The laminated PET film 96 is then coated at station 98 using a UV opacity ink applied via flexography, primed at station 100, printed in the digital press 102, and UV topcoated at station 104. In the embodiment shown in FIG. 3B, the topcoat is provided with a texture by a textured film 106 that is unwound by roll 108 and rewound by roll 110. The laminate with the textured topcoat then moves to a heat laminating station 112 where it is heat laminated to the final carrier sheet 16, and slit at a slitting station 114 to final width and length, and rewound at roll 116. Such a system can be combined with a personal computer and appropriate software (e.g. MATLAB® and Adobe® Photoshop®) to allow consumers to design their own architectural surface coverings and print them instantly. An example of a unit suitable for UV topcoating, laminating and slitting is made by Grafisk Maskinfabrik A/S, Denmark.

### EXAMPLES

The following are non-limiting examples of multi-layer laminates. Example 1 has a white opacity layer and primer. Examples 2-4 have a colored opacity layer with a transparent primer. Example 5 has a white or colored opacity layer with no primer.

### Example 1

A pigmented pressure sensitive adhesive (PSA) layer is applied to a polyester carrier at a coat weight of 13 to 20 grams per square meter. The polyester carrier comprises a Toray LuMirror F53 14G 3.5 μm biaxially oriented PET film obtained from Toray Industries, Inc. of Tokyo, Japan. The PSA is applied to the second surface of the aforementioned PET film by transfer lamination. Corona treatment of the second surface may be used to increase adhesion of the PSA to the untreated surface of the PET film. The dry film thickness of the PSA is from about 0.45 to 0.70 mil. The PSA is available from Avery Dennison Corporation under product number S-3526 and the formulation for the PSA is as follows (with numerical values in parts per hundred weight):

| Component | Parts |
|---|---|
| S-3506 (product of Avery Dennison, Performance | 96.0 |
| Polymers, a cross-linked copolymer emulsion of butyl | |
| acrylate and 2-ethyl hexyl acrylate) | |
| UCD 110GE (white TiO₂ pigment dispersion from Rohm | 3.7 |
| and Haas) | |
| UCD 1507E (carbon black pigment dispersion from | 0.3 |
| Rohm and Haas) | |

Opacifying layers are then sequentially gravure printed onto the first surface of the PET substrate film. The coatings are applied to the first surface of the substrate film in the following sequence: opacifying layer 1, opacifying layer 2, opacifying layer 3, opacifying layer 4, and opacifying layer 5 to provide a total dry coat weight of approximately 15-30 gsm. The substrate film with the applied coatings comprises the opacified substrate. The first surface of the opacified substrate is the opacified layer and the second surface of the opacified substrate is formed by the second surface of the adhesive transfer tape.

Each of the opacifying layers is coated at about 4 to 6 grams per square meter dry weight basis. The opacifying layers comprise Siegwerk FSBA9U0CW modified F11 NA white. The NA coatings are preferred as they do not contain larger particle silica matting agents or polyethylene waxes which may affect coating quality of subsequent layers. The NA coatings comprise polyurethane, TiO₂, silica, pigment, and a solvent system comprising butyl acetate, ethyl alcohol, isopropyl alcohol, n-propyl acetate, and n-propyl alcohol.

The opacified film is then coated with a primer that enhances print adhesion of the digital aqueous inks. The primer may be transparent, translucent, or colored. The transparent primer may be IJ-1007 NS available from Cork Industries, Inc. The translucent primer may be IJ-1014 from Cork Industries, Inc. In one embodiment, the primer is applied using rod coating to deliver 5 to 10 gsm dry basis. Alternately, gravure, microgravure or other coating methods known in the art may be used to coat the primer layer.

After priming, the primed film is printed using aqueous inkjet inks. One example of a suitable aqueous inkjet press is the InfoPrint 5000 supplied by InfoPrint Solutions, Boulder, Colo. U.S.A. This aqueous inkjet press uses cyan, magenta, yellow and black pigment inks to print the color and design portion of the article. The digital printer is first profiled to account for the color of the substrate and to adjust ink usage so that the final digitally printed article matches the desired color. The profiling of the printer may be done using commercially available equipment such as the X-Rite i1-iSis or i1iO chart readers and ProfileMaker Professional software available from X-Rite, Grand Rapids Mich. 49512 USA.

After printing, a UV curable resin is applied as a topcoat overlying the printed color layers. This resin may be applied using a traditional coating method such as flexographic printing. The topcoat is coated at a 2 gram per square meter dry weight basis to form a continuous layer of UV curable resin. One example of a commercially available topcoat resin is CU-1170HG-49 from Cork Industries, Inc. After coating, a film which has been modified to provide the desired gloss, texture or other surface effect is applied on the upper surface of the UV curable resin. One commercially available film is LS-10 film available from Breit Technologies, Lenexa, Kans., U.S.A. The resin is then cured using a system such as UV or electron beam energy. The film is then removed, rewound and reused. The film may be modified as desired to provide a variety of gloss or surface effects that may be continuous or discontinuous.

In a further embodiment, the film may be left attached to the topcoat and removed at the final point of application. This may be desirable in order to potentially eliminate the need for an additional carrier film and unit operation to apply a carrier film.

If the textured film is not used in place of a carrier film, a separate PET carrier sheet 36, such as Mitsubishi 75 gauge 2SLK film, is coated on its first side with a silicone release coating 38. This corresponds to the adhesive release coat layer described above. The thickness of the silicone coated liner is 0.75 mil (19.0 μm).

A tie layer of 26% Vinyl Acetate content EVA is coextruded with an EVA copolymer containing 95-98% LDPE or LLDPE with 2%-5% of Vinyl Acetate onto the second side of the PET carrier sheet. Suitable materials include MARFLEX™ 1017 LDPE from Chevron Phillips, The Woodland, Tex., USA, Dowlex 2045 or 2035 LLDPE from Dow Chemical, Midland, Mich., USA, Elvax 750 (9% Vinyl Acetate by weight) or Elvax 550 (15% Vinyl Acetate by weight) from Dupont, Wilmington, Del., USA. A preferred mode is to blend 83.3% of Dowlex 2035 with 16.7% of Elvax 550 to make a blend with 2.5% VA content.

The carrier sheet made above is then heat-laminated to the dry color component at a temperature of about 275° F. to 325° F. (135° C. to 163° C.). When one component is heat-laminated to another component, a bond is formed where at least one of the components is at least partially melted (or fused) onto the surface of the other component. During lamination, the nip is set with positive stops. The pressure used is sufficient to prevent the rolls from separating from this fixed nip point. The use of the positive nip means the pressure is based on the composition and deflection of the rubber roll by the heated steel roll. Representative processing conditions use a deflection of 10 to 20 thousandths of an inch and a 65 or 85 durometer rubber roll. Pressures are approximately 25-90 psi but may be adjusted as needed to control release force and adhesion. In addition, one skilled in the art will recognize the ability to control the bonding quality of the carrier sheet by adjusting the coating composition of the carrier film, laminating drum temperature, amount of wrap on the heated drum prior to the nip, amount of wrap on the heated drum after the nip, or amount of deflection of the heated drum into the rubber roll.

### Example 2

A laminated PET film is prepared as in Example 1 and coated with opacifying layers in a similar manner. The opacifying layers comprise Siegwerk FSBA9U0CW modified F11 NA white with Siegwerk blue pigment.

The opacified film is then coated with a primer that enhances print adhesion. In this embodiment, a transparent primer is used so as to not substantially change the color of the opacity layer; however, a translucent primer can be used if desired. A typical commercial example of a transparent primer is IJ-1007 NS from Cork Industries, Inc. In this embodiment, the primer is applied using rod coating to deliver 5 to 10 gsm dry basis. Alternatively, gravure, microgravure or other coating methods may be used to coat the primer layer in single or multiple steps.

After priming, the primed opacified film is printed using aqueous inkjet inks as in Example 1. The printed web is then topcoated and laminated as described in Example 1.

### Example 3

A laminated PET film is prepared as in Example 1 and coated with opacifying layers in a similar manner. The opacifying layers comprise Siegwerk FSBA9U0CW modified F11 NA white with Siegwerk red pigment. The colored film is then primed and printed as in Example 2. The printed web is then topcoated and laminated as described in Example 1.

### Example 4

A laminated PET film is prepared as in Example 1 and coated with opacifying layers in a similar manner. The opacifying layers comprise Siegwerk FSBA9U0CW modified F11 NA white with Siegwerk green pigment. The colored film is then primed and printed as in Example 2. The printed web is then topcoated and laminated as described in Example 1.

### Example 5

A laminated PET film is prepared and opacified as in Examples 1-4. The unprimed opacified film is then printed. One suitable printer is the Xeikon 6000 or Xeikon 8000 dry toner based printer available from Punch Graphix, Lier, Belgium. A second suitable printer is the Dotrix Modular UV inkjet press available from Agfa, Mortsel, Belgium. A third suitable printer is the HP Scitex XP 2700 UV inkjet press from HP, Palo Alto, Calif., U.S.A. The digital printer is profiled to account for the color of the substrate to deliver the desired final color. The printed web is then topcoated and laminated as described in Example 1.

It should be understood that any advantages or benefits described herein need not be provided unless they are specified in the appended claims.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of making a customizable multi-layer laminate for applying a color image on an architectural surface, said method comprising:
(a) providing a user with at least one graphic element to use in forming the color image;
(b) providing the user with the ability to select at least one color for the laminate; and
(c) printing the color image on the multi-layer laminate using a digital printer using the graphic element provided to the user and the color selected by the user.

2. A method of making a customizable multi-layer laminate for applying a color image on an architectural surface, said method comprising:
(a) providing a user with the ability to select a graphic element to use in forming the color image;
(b) providing a computer for altering the graphic element to randomize the graphic element and make the laminate with the randomized graphic element thereon patchable;
(c) providing the user with the ability to select at least one color for the laminate; and
(d) printing the color image on the multi-layer laminate using a digital printer using the randomized graphic element and the color selected by the user.

3. The method of claim 2 wherein further comprising providing the user with a selection of more than one adhesive for attaching the multi-layer laminate to an architectural surface, wherein an adhesive is to be joined to one side of said multi-layer laminate, wherein the user is provided the ability to select an adhesive.

4. A method of making a customizable multi-layer laminate for applying a color image on an architectural surface, said method comprising:
(a) providing a user with the ability to select a graphic element or design to use in forming the color image, said image oriented in the typical normal viewing orientation for a human whose eye line is generally parallel to the floor or ground;
(b) providing a computer for altering the graphic element;
(c) orienting said graphic element or design in an x-y grid;
(d) determining a horizontal and vertical axis as defined by placement of the element in an x-y grid;
(e) randomizing the graphic element to provide a plurality of design elements such that at least 60% of the final design area comprises each image of the element and no more than 20% of said plurality of images has their horizontal or vertical axes substantially parallel to either the x or y axis of the x-y grid referenced above;
(f) providing the user with the ability to select at least one color for the laminate; and
(g) printing the color image on the multi-layer laminate using a digital printer using the randomized graphic element and the color selected by the user.
